(19) United States
(12) Patent Application Publication
(10) Pub. No.: US 2012/0328061 A1
(43) Pub. Date: Dec. 27, 2012

(54) METHOD, APPARATUS, AND COMPUTER PROGRAM PRODUCT FOR USING DISCOVERED CLOCK IN A FIRST COMMUNICATIONS PROTOCOL TO SYNCHRONIZE NETWORKING ACTIVITY IN A SECOND COMMUNICATIONS PROTOCOL

(75) Inventor: Brian CHOW, Farnham (GB)

(73) Assignee: Nokia Corporation, Espoo (FI)

(21) Appl. No.: 13/169,635

(22) Filed: Jun. 27, 2011

(51) Int. Cl. H04W 56/00

(52) U.S. Cl. 375/354

(57) ABSTRACT

Method, apparatus, and computer program product example embodiments use native clock timing of a first wireless communications protocol to establish synchronization of a wireless network of a second wireless communications protocol. According to an example embodiment of the invention, a method comprises maintaining a native clock time in a first wireless communications protocol; activating one or more wireless messages in a second wireless communications protocol, based on the native clock time of the first wireless communications protocol; receiving a wireless message in the first wireless communications protocol; and transmitting one or more second wireless messages in the first wireless communications protocol, including information related to the native clock time, to enable a receiving apparatus to synchronize its activation of one or more messages in the second wireless communications protocol, with the one or more wireless messages activated in the second wireless communications protocol.

### FIELD

The field of the invention relates to wireless short-range communication and more particularly to using native clock timing of a first wireless communications protocol to establish synchronization of a network of a second wireless communications protocol.

### BACKGROUND

Modern society has adopted, and is becoming reliant upon, wireless communication devices for various purposes, such as, connecting users of the wireless communication devices with other users. Wireless communication devices can vary from battery powered handheld devices to household and/or commercial devices utilizing electrical network as a power source. Due to rapid development of the wireless communication devices a number of areas capable of enabling entirely new types of communication applications have emerged.

Cellular networks facilitate communication over large geographic areas. These network technologies have commonly been divided by generations, starting in the late 1970s to early 1980s with first generation (1G) analog cellular telephones that provided baseline voice communications, to modern digital cellular telephones. GSM is an example of a widely employed 2G digital cellular network communicating in the 900 MHZ/1.8 GHZ bands in Europe and at 850 MHz and 1.9 GHZ in the United States. While long-range communication networks, such as GSM, are a well-accepted means for transmitting and receiving data, due to cost, traffic and legislative concerns, these networks may not be appropriate for all data applications.

Short-range communication technologies provide communication solutions that avoid some of the problems seen in large cellular networks. Bluetooth™ is an example of a short-range wireless technology quickly gaining acceptance in the marketplace. In addition to Bluetooth™ other popular short-range communication technologies include Bluetooth™ Low Energy, IEEE 802.11 wireless local area network (WLAN), Wireless USB (WUSB), Ultra Wide-band (UWB), ZigBee (IEEE 802.15.4, IEEE 802.15.4a), and ultra high frequency radio frequency identification (UHF RFID) technologies. All of these wireless communication technologies have features that make them appropriate for various applications.

### SUMMARY

Method, apparatus, and computer program product example embodiments use native clock timing of a first wireless communications protocol to establish synchronization of an ad hoc network of a second wireless communications protocol.

Example embodiments of the invention maintain a native clock time in a first wireless communications protocol, for example a short-range wireless protocol, in a first wireless device. The first wireless device is a dual radio device that periodically activates for short periods of time a second wireless communications protocol, for example a WLAN protocol. The first wireless communications protocol is used to indicate the periodic activation and deactivation of the second wireless communications protocol so that each activation is a separate instance of a short-lived ad-hoc network in the second wireless communications protocol. The activation begins at time instants based on a predetermined value of the native clock time of the first wireless communications protocol. The period of activation ends after a short interval, with the deactivation of the second wireless communications protocol.

The first device receives a wireless message in the first wireless communications protocol, such as an inquiry request packet from a second wireless device that is also a dual radio device. In response, the first wireless device transmits one or more second wireless messages in the first wireless communications protocol, such as an inquiry response packet and an extended inquiry response packet, including information related to the native clock time and an offset value. In this manner, the receiving second device is enabled to synchronize activation of the second wireless communications protocol for short periods of time beginning at the same periodic time instants, using its own native clock. In embodiments of the invention, a value for the duration Δ of the short period of activation may be stored in each of the devices. In alternate embodiments of the invention, the value of the duration Δ of the short period of activation may be transmitted by the first device in the one or more second wireless messages to the second device.

The second device may further synchronize activation of the second wireless communications protocol in a third dual radio wireless device, for short periods of time beginning at the same periodic time instants, using its own native clock, by transmitting to the third device one or more second wireless messages in the first wireless communications protocol, such as an inquiry response packet and an extended inquiry response packet, including information related to the native clock time and an offset value.

According to an example embodiment of the invention, a method comprises:

maintaining a native clock time in a first wireless communications protocol;

activating one or more wireless messages in a second wireless communications protocol, based on the native clock time of the first wireless communications protocol;

receiving a wireless message in the first wireless communications protocol; and

transmitting one or more second wireless messages in the first wireless communications protocol, including information related to the native clock time, to enable a receiving apparatus to synchronize its activation of one or more messages in the second wireless communications protocol, with the one or more wireless messages activated in the second wireless communications protocol.

According to an example embodiment of the invention, an apparatus comprises:

at least one processor;

at least one memory including computer program code;

the at least one memory and the computer program code configured to, with the at least one processor, cause the apparatus at least to:

maintain a native clock time in a first wireless communications protocol;

activate one or more wireless messages in a second wireless communications protocol, based on the native clock time of the first wireless communications protocol;

receive a wireless message in the first wireless communications protocol; and

transmit one or more second wireless messages in the first wireless communications protocol, including information related to the native clock time, to enable a receiving apparatus to synchronize its activation of one or more messages in the second wireless communications protocol, with the one or more wireless messages activated in the second wireless communications protocol.

According to an example embodiment of the invention, a computer program product comprises computer executable program code recorded on a computer readable non-transitory storage medium, the computer executable program code, when executed by a computer processor, causing performance of the steps of:

maintaining a native clock time in a first wireless communications protocol;

activating one or more wireless messages in a second wireless communications protocol, based on the native clock time of the first wireless communications protocol;

receiving a wireless message in the first wireless communications protocol; and

transmitting one or more second wireless messages in the first wireless communications protocol, including information related to the native clock time, to enable a receiving apparatus to synchronize its activation of one or more messages in the second wireless communications protocol, with the one or more wireless messages activated in the second wireless communications protocol.

According to an example embodiment of the invention, a method comprises:

transmitting at least one first wireless message in a first wireless communications protocol;

receiving one or more second wireless messages in the first wireless communications protocol from another apparatus in response to the at least one transmitted first message, including information related to a native clock time, to enable synchronizing activation of one or more messages in a second wireless communications protocol, with wireless messages activated by the another apparatus in the second wireless communications protocol; and

activating one or more wireless messages in the second wireless communications protocol, based on the received information related to the native clock time of the first wireless communications protocol.

According to an example embodiment of the invention, an apparatus comprises:

at least one processor;

at least one memory including computer program code;

the at least one memory and the computer program code configured to, with the at least one processor, cause the apparatus at least to:

transmit at least one first wireless message in a first wireless communications protocol;

receive one or more second wireless messages in the first wireless communications protocol from another apparatus in response to the at least one transmitted first message, including information related to a native clock time, to enable synchronizing activation of one or more messages in a second wireless communications protocol, with wireless messages activated by the another apparatus in the second wireless communications protocol; and

activate one or more wireless messages in the second wireless communications protocol, based on the received information related to the native clock time of the first wireless communications protocol.

According to an example embodiment of the invention, a computer program product comprises computer executable program code recorded on a computer readable non-transitory storage medium, the computer executable program code, when executed by a computer processor, causing performance of the steps of:

transmitting at least one first wireless message in a first wireless communications protocol;

receiving one or more second wireless messages in the first wireless communications protocol from another apparatus in response to the at least one transmitted first message, including information related to a native clock time, to enable synchronizing activation of one or more messages in a second wireless communications protocol, with wireless messages activated by the another apparatus in the second wireless communications protocol; and

activating one or more wireless messages in the second wireless communications protocol, based on the received information related to the native clock time of the first wireless communications protocol.

The resulting example embodiments use native clock timing of a first wireless communications protocol to establish synchronization of an ad hoc network of a second wireless communications protocol.

### DESCRIPTION OF THE FIGURES

FIG. 1A illustrates an example network diagram of an initiator device A and a discoverer device B, where each device is a dual radio that includes wireless short-range communication technology such as for example a Bluetooth™ radio and a wireless local area network (WLAN) radio, in accordance with at least one embodiment of the present invention.

FIG. 1B illustrates an example timing diagram of the initiator device A of FIG. 1A, showing an example relationship between the Bluetooth™ clock of the Bluetooth™ radio and the WLAN activity of the WLAN radio, in accordance with at least one embodiment of the present invention.

FIG. 1C illustrates an example timing diagram of the discoverer device B of FIG. 1A, showing the transmitting of example Bluetooth™ packets by the discoverer device B and receiving example Bluetooth™ packets from the initiator device A, and showing the resulting synchronized WLAN activity of the WLAN radio of discoverer device B, in accordance with at least one embodiment of the present invention.

FIG. 1D illustrates a more detailed example timing diagram of the initiator device A and discoverer device B of FIG. 1A, in accordance with at least one embodiment of the present invention.

FIG. 2 is an example of the Bluetooth™ extended inquiry response packet, which includes an extended inquiry response data type that designates it as a WLAN beacon synchronization type, in accordance with at least one embodiment of the present invention.

FIG. 3 illustrates an example network diagram of an ad hoc network that includes the initiator device A and the discoverer device B of FIG. 1A and two additional devices C and D similar to devices A and B, in accordance with at least one embodiment of the present invention.

FIG. 4 is an example functional block diagram of the initiator device A and the discoverer device B of FIG. 1A, in accordance with at least one embodiment of the present invention.

FIG. 5A illustrates an example embodiment of a wireless ad hoc network wherein each device is a dual radio that includes wireless short-range communication technology such as for example a Bluetooth™ radio and a WLAN radio, in accordance with at least one embodiment of the present invention.

FIG. 5B illustrates an example timing diagram of the wireless ad hoc third device STA-MP3 and wireless ad hoc fourth device STA-MP4 of FIG. 5A, in accordance with at least one embodiment of the present invention.

FIG. 5C is a more detailed illustration of the timing diagram of FIG. 5B, showing an example of the beacons and data frames transmitted during one WLAN activity epoch, in accordance with at least one embodiment of the present invention.

FIG. 6A is an example flow diagram of operational steps in the initiator device A of FIG. 1A, using native clock timing of a first wireless communications protocol to establish synchronization of an ad hoc network of a second wireless communications protocol, in accordance with at least one embodiment of the present invention.

FIG. 6B is an example flow diagram of operational steps in the discovering device B of FIG. 1A, using native clock timing of a first wireless communications protocol to establish synchronization of an ad hoc network of a second wireless communications protocol, in accordance with at least one embodiment of the present invention.

FIG. 7 illustrates an example network diagram of an initiator device A and a discoverer device B, where each device is a dual radio that includes a generalized short-range radio in device A and in device B and a generalized wireless local area network (WLAN) radio in device A and in device B, in accordance with at least one embodiment of the present invention.

FIG. 8A illustrates an example network diagram of an initiator device A and a discoverer device B, where each device is a dual radio that includes a generalized short-range radio in device A and in device B and an IEEE 802.11 radio in device A and in device B, in accordance with at least one embodiment of the present invention.

FIG. 8B illustrates an example network diagram of an initiator device A and a discoverer device B, where each device is a dual radio that includes a generalized short-range radio in device A and in device B and a HIPERLAN radio in device A and in device B, in accordance with at least one embodiment of the present invention.

### DISCUSSION OF EXAMPLE EMBODIMENTS OF THE INVENTION

This section is organized into the following topics:

A. Bluetooth™ Communication Technology

B. WLAN Communication Technology

C. Discovered Bluetooth™ Clock To Synchronize WLAN Network Activity

D. Discovered Bluetooth™ Clock To Synchronize Ad Hoc Networks

A. Bluetooth™ Communication Technology

An example of a wireless short-range communication technology is Bluetooth™ communication protocol, which operates in the 2.4 GHz ISM band. Bluetooth™ is a short-range radio network, originally intended as a cable replacement. Bluetooth™ Technical Specifications are published by the Bluetooth™ SIG, Inc. On Jun. 30, 2010, the Bluetooth™ SIG published the Bluetooth™ Core Specification, Version 4.0, which includes the basic rate/enhanced data rate (BR/EDR) and additionally, the Bluetooth low energy (LE) protocol. The Bluetooth™ BR/EDR includes the extended inquiry response (EIR). An extended inquiry response may be used to provide miscellaneous information during the inquiry response procedure. Data types may be defined for such things as local name and supported services, information that otherwise would have to be obtained by establishing a connection. A device that receives a local name and a list of supported services in an extended inquiry response does not have to connect to do a remote name request and a service discovery protocol (SDP) service search, thereby shortening the time to useful information.

A procedure for forming connections between Bluetooth™ BR/EDR devices is described in the Bluetooth™ Specification. The Bluetooth™ Baseband is the part of the Bluetooth™ system that implements the media access control (MAC) and physical layer procedures to support the connection formation, exchange of data information streams, and ad hoc networking between Bluetooth™ devices. Connection formation includes inquiry, inquiry scanning, inquiry response, extended inquiry response, paging, page scanning, and page response procedures.

1. Bluetooth™ BR/EDR Inquiry Request

Inquiry is a procedure where a Bluetooth™ BR/EDR device transmits inquiry messages and listens for responses in order to discover the other Bluetooth™ devices that are within the coverage area. Bluetooth™ devices use the inquiry procedure to discover nearby devices, or to be discovered by devices in their locality. A Bluetooth™ device that tries to find other nearby devices is known as an inquiring device and actively sends inquiry requests. Bluetooth™ devices that are available to be found are known as discoverable devices, listen or scan for these inquiry requests and send responses. The inquiry procedure uses dedicated physical channels for the inquiry requests and responses. The inquiry procedure does not make use of any of the architectural layers above the physical channel, although a transient physical link may be considered to be present during the exchange of inquiry and inquiry response information.

Inquiry scan is a procedure where a Bluetooth™ BR/EDR device listens for inquiry messages received on its inquiry scan physical channel. A device using one of its inquiry scan channels remains passive on that channel until it receives an inquiry message on this channel from another Bluetooth™ device. This is identified by the appropriate inquiry access code. The inquiry scanning device will then follow the inquiry response procedure to return a response to the inquiring device.

2. Bluetooth™ BR/EDR Inquiry Response

An inquiry response packet, which is a frequency hop synchronization (FHS) packet, is transmitted from the slave to the master after the slave has received an inquiry message. This packet contains information necessary for the inquiring master to page the slave and follows 625 microseconds after the receipt of the inquiry message. The inquiry response packet is received by the master at the hop frequency of the inquiry message received by the slave was first in the master-to-slave slot. The slave response substate for inquiries differs completely from the slave response substate applied for pages. When the inquiry message is received in the inquiry scan substate, the recipient may return an inquiry response (FHS) packet containing the recipient's device address (BD_ADDR), clock, and class of device.

The clock CLK₂₇₋₂ in the FHS inquiry response packet is a 26-bit field that contains the value of the native clock CLKN of the device that sends the FHS packet, sampled at the beginning of the transmission of the access code of this FHS packet. This clock value has a resolution of 1.25 ms (two-slot interval). For each new transmission, this field is updated so that it accurately reflects the real-time clock value CLKN.

On the first inquiry message received in the inquiry scan substate the slave may enter the inquiry response substate. If the slave has non-zero extended inquiry response data to send it may return an FHS packet to the master, with the extended inquiry response bit set to one, 625 microseconds (μs) after the inquiry message was received. It may then return an extended inquiry response packet 1250 microseconds after the start of the FHS packet. If the slave's extended inquiry response data is all zeroes the slave may only return an FHS packet with the extended inquiry response bit set to zero. In step 1, the master transmits an inquiry request packet using the inquiry access code (IAC). In step 2, the slave responds with the FHS packet containing the slave's Bluetooth™ device address, native clock CLKN and other slave information. This FHS packet is returned at times that tend to be random. The FHS packet is not acknowledged in the inquiry routine, but it is retransmitted at other times and frequencies as long as the master is probing with inquiry messages. If the slave has non-zero extended inquiry response data, it sends an extended inquiry response packet to the master in step 3.

3. Bluetooth™ BR/EDR Extended Inquiry Response

An extended inquiry response may be used to provide miscellaneous information during the inquiry response procedure. Data types are defined for such things as local name and supported services, information that otherwise would have to be obtained by establishing a connection. A device that receives a local name and a list of supported services in an extended inquiry response does not have to connect to do a remote name request and a service discovery protocol (SDP) service search, thereby shortening the time to obtain useful information. If the slave transmits an extended inquiry response packet, it is transmitted 1250 microseconds after the start of the inquiry response packet. The extended inquiry response packet is received by the master at the hop frequency when the inquiry message was received by the slave in the master-to-slave slot. The extended inquiry response packet is an asynchronous connection-oriented logical transport (ACL) data medium rate (DM) packet with type DM1, DM3, DM5, DH1, DH3 or DH5. The packet is sent on the same frequency as the (frequency hop synchronization) FHS packet, 1250 microseconds after the start of the FHS packet.

The payload data has two parts, a significant part followed by a non-significant part. The significant part contains a sequence of data structures. The non-significant part contains all zero octets. The baseband may not change any octets in the significant part. When transmitting data, the non-significant part octets may be omitted from the payload. A device may store a single extended inquiry response packet. This packet may be used with all inquiry access codes (IACs).

4. Bluetooth™ Clock

The Bluetooth™ basic piconet physical channel is divided into time slots, each 625 μs in length. The time slots are numbered according to the most significant 27 bits of the Bluetooth™ clock CLK₂₈₋₁ of the piconet master. The slot numbering ranges from 0 to 2²⁷−1 and is cyclic with a cycle length of 2²⁷. The time slot number is denoted as k. A time domain duplex (TDD) scheme is used where master and slave alternately transmit. The packet start is aligned with the slot start. CLK is the master clock of the piconet. It is used for all timing and scheduling activities in the piconet. All devices use the CLK to schedule their transmission and reception. The CLK is derived from the native clock CLKN by adding an offset. The offset is zero for the master since CLK is identical to its own native clock CLKN. Each slave adds an appropriate offset to its CLKN such that the CLK corresponds to the CLKN of the master. Although all CLKNs in the devices run at the same nominal rate, mutual drift causes inaccuracies in CLK. Therefore, the offsets in the slaves are regularly updated such that CLK is approximately CLKN of the master.

The master transmission starts at even numbered time slots (CLK bit 1 equals 0 or CLK₁=0) and the slave transmission always starts at odd numbered time slots (CLK bit 1 equals 1 or CLK₁=1). Due to packet types that cover more than a single slot, master transmission may continue in odd numbered slots and slave transmission may continue in even numbered slots.

The channel hopping frequencies f(k) change with the time slot number k. After transmission, a return packet is expected 625 μs after the start of the transmitted packet, depending on the type of the transmitted packet. Each master transmission is derived from bit 2 of the Master's native Bluetooth™ clock CLKN, thus the current transmission will be scheduled M×1250 μs after the start of the previous master transmitted (TX) burst, where M depends on the transmitted and received packet type and is an even, integer larger than 0. The master TX timing is derived from the master's native Bluetooth™ clock CLKN, and thus it will not be affected by time drifts in the slave devices.

Slave devices maintain an estimate of the master's native clock CLKN by adding a timing offset to the slave's native clock. This offset is updated each time a packet is received from the master. By comparing the exact received (RX) timing of the received packet with the estimated RX timing, slaves may correct the offset for any timing misalignments. Since only the channel access code is required to synchronize the slave, slave RX timing may be corrected with any packet sent in the master-to-slave transmission slot. The slave's transmission is scheduled 625 μs after the start of the slave's RX packet. If the slave's RX timing drifts, so will its TX timing.

5. Bluetooth™ Host Controller Interface

The host controller interface (HCI) is described in the Bluetooth™ Core Specification. The HCI provides a command interface between the host application in a device and the Bluetooth™ link layer, provides access to hardware status and control registers of the Bluetooth™ radio, and provides a uniform method of accessing the Bluetooth™ baseband capabilities. Some of the HCI commands and events are described as follows.

HCI Read Clock Command:

This command reads the estimate of the value of the Bluetooth™ Clock CLKN from the device's controller and passes it on to the Host. If the Which_Clock value is 0, then the Connection_Handle is ignored and the local Bluetooth™ Clock value is returned and the accuracy parameter is set to 0. If the Which_Clock value is 1, then the Connection_Handle is a valid Asynchronous Connection-oriented Logical transport (ACL) Connection_Handle. If the current role of this ACL connection is Master, then the Bluetooth™ Clock CLKN of this device is returned. If the current role is Slave, then an estimate of the Bluetooth™ Clock of the remote master and the accuracy of this value are returned. The accuracy reflects the clock drift that might have occurred since the slave last received a valid transmission from the master.

HCI Read Clock Offset Command:

Both the system clock and the clock offset to a remote device are used to determine what hopping frequency is used by a remote device for page scan. This command allows the host to read clock offset to remote devices. The clock offset may be used to speed up the paging procedure when the local device tries to establish a connection to a remote device, for example, when the local host has issued Create_Connection or Remote_Name_Request. The Connection_Handle must be a Connection_Handle for an ACL connection.

HCI Inquiry Result Event:

The inquiry result event indicates that a remote device has responded with an inquiry response packet during the current Inquiry process. This event will be sent from the Bluetooth™ Controller to the Host as soon as an Inquiry Response from a remote device is received. The event parameters sent to the Host include BD_ADDR and Class_of_Device of the remote device and Clock_Offset between the remote device and the inquiring device.

HCI Write Extended Inquiry Response Command:

The Write_Extended_Inquiry_Response command writes the extended inquiry response to be sent to an inquiring device during the extended inquiry response procedure. The write extended inquiry response command will write the data that the device's host wishes to send in the extended inquiry response packet during inquiry response. The FEC_Required command parameter states if forward error correction (FEC) encoding is required. The initial value of the inquiry response data is all zero octets. The controller does not interpret the extended inquiry response data, but passes it on to the baseband medium access control and physical radio for transmission in an EIR packet.

HCI Extended Inquiry Result Event:

The extended inquiry result event indicates that another Bluetooth™ device has responded during the current inquiry process with extended inquiry response data. Data received in this event will be sent from the device's Controller to the Host upon reception of an EIR from a remote device. One single extended inquiry response is returned per event. This event contains received signal strength indication (RSSI) and inquiry response data for the device that responded to the latest inquiry. The RSSI parameter is measured during the FHS packet returned by each responding slave. The Num_Responses parameter is set to one. If an extended inquiry response packet from the same remote device is correctly received in a later response, another event is generated. The Extended_Inquiry_Response parameter is not interpreted by the controller. The tagged data received from the remote device is passed unaltered to the host, if it has been correctly received.

6. Bluetooth™ Low Energy (LE)

On Jun. 30, 2010, the Bluetooth SIG published the Bluetooth Core Specification, Version 4.0, which includes the Bluetooth LE protocol for products that require lower power consumption, lower complexity, and lower cost than would be possible using the BR/EDR protocol. Bluetooth LE is designed for applications requiring lower data rates and shorter duty cycles, with a very-low power idle mode, a simple device discovery, and short data packets. Bluetooth LE devices may employ a star topology, where one device serves as a master for a plurality of slave devices, the master dictating connection timing by establishing the start time of the first connection event and the slave devices transmitting packets only to the master upon receiving a packet from the master. According to Bluetooth LE communication protocol all connections are point-to-point connections between two devices (the master and the slave).

The Bluetooth LE protocol allows a star network topology in connections, where one device serves as a master for a plurality of slave devices. The master device dictates the connection timing and communication operations of the one or more slave devices. Bluetooth LE communicates over a total of 40 RF channels, each having a bandwidth of 2 MHz. Data communication between Bluetooth LE devices occurs in 37 pre-specified data channels, of the 40 RF channels. All data connection transmissions occur in connection events wherein a point-to-point connection is established between the master device and a slave device. In the Bluetooth LE protocol, a slave device provides data through Bluetooth LE communication to the master device to which it is connected. The remaining 3 channels, of the 40 RF channels, are advertising channels used by devices to advertise their existence and capabilities. The Bluetooth LE protocol defines a unidirectional connectionless broadcast mode on the advertising channels.

The Link Layer provides a state machine with the following five states: Standby State, Advertising State, Scanning State, Initiating State, and Connection State. The Link Layer state machine allows only one state to be active at a time. The Link Layer in the Standby State does not transmit or receive any packets and can be entered from any other state. The Link Layer in the Advertising State will be transmitting advertising channel packets and possibly listening to and responding to responses triggered by these advertising channel packets. A device in the Advertising State is known as an advertiser. The Advertising State can be entered from the Standby State. The Link Layer in the Scanning State will be listening for advertising channel packets from devices that are advertising. A device in the Scanning State is known as a scanner. The Scanning State can be entered from the Standby State. The Link Layer in the Initiating State will be listening for advertising channel packets from a specific device and responding to these packets to initiate a connection with that specific device. A device in the Initiating State is known as an initiator. The Initiating State can be entered from the Standby State. The Connection State of the Link Layer may be entered either from the Initiating State or the Advertising State. A device in the Connection State is known as being in a connection over a data channel. Within the Connection State, two roles are defined: the Master Role and the Slave Role. When a device in the Initiating State, enters the Connection State, it is in the Master Role, it exchanges data packets with a slave device in a data channel, and it defines the timings of transmissions. When a device in the Advertising State, enters the Connection State, it is in the Slave Role and exchanges data packets with a master device in a data channel, wherein the master device defines the timings of transmissions.

The Bluetooth LE radio operates in the unlicensed 2.4 GHz ISM band, in the same manner as does the Basic Rate/Enhanced Data Rate (BR/EDR) radio. Bluetooth LE supports very short data packets, from 8 octets to a maximum of 27 octets, giving it a low duty cycle. Bluetooth LE employs a frequency hopping transceiver with many frequency hopping spread spectrum (FHSS) carriers, with a bit rate of 1 Megabit per second (Mb/s).

B. WLAN Communication Technology

The IEEE 802.11 standard specifies methods and techniques of an exemplary wireless local area network (WLAN) operation. Examples include the IEEE 802.11b and 802.11g wireless local area network specifications, which have been a staple technology for traditional WLAN applications in the 2.4 GHz ISM band. The various amendments to the IEEE 802.11 standard were consolidated for IEEE 802.11a, b, d, e, g, h, i, j protocols, into the base standard IEEE 802.11-2007, Wireless Medium Access Control (MAC) and Physical Layer (PHY) Specifications, June 2007. Since then, emerging broadband applications have stimulated interest in developing very high-speed wireless networks for short range communication, for example, the IEEE 802.11n, the planned IEEE 802.11 ac, and the planned IEEE 802.11 ad WLAN specifications that are to provide a very high throughput in higher frequency bands. Applications of these IEEE 802.11 standards include products such as consumer electronics, telephones, personal computers, and access points for both for home and office.

A WLAN may be organized as an independent basic service set (IBSS) or an infrastructure basic service set (BSS). Wireless devices in an independent basic service set (IBSS) communicate directly with one another and there is no access point in the IBSS. WLAN ad hoc networks have an independent configuration where the mobile devices communicate directly with one another, without support from a fixed access point. WLAN ad hoc networks support distributed activities similar those of the Bluetooth™ piconets. The IEEE 802.11 standard provides wireless devices with service inquiry features similar to the Bluetooth™ inquiry and scanning features.

The independent basic service set (IBSS) has a BSS Identifier (BSSID) that is a unique identifier for the particular ad hoc network. Its format is identical to that of an IEEE 48-bit address. In an ad hoc network, the BSSID is a locally administered, individual address that is generated randomly by the device that starts the ad hoc network.

Synchronization is the process of the devices in an ad hoc network getting in step with each other, so that reliable communication is possible. The MAC provides the synchronization mechanism to allow support of physical layers that make use of frequency hopping or other time-based mechanisms where the parameters of the physical layer change with time. The process involves beaconing to announce the presence of an ad hoc network, and inquiring to find an ad hoc network. Once an ad hoc network is found, a device joins the ad hoc network. This process is entirely distributed in ad hoc networks, and relies on a common timebase provided by a timer synchronization function (TSF). The TSF may maintain a 64-bit timer running at 1 MHz and updated by information from other devices. When a device begins operation, it may reset the timer to zero. The timer may be updated by information received in beacon frames.

In an ad hoc network, since there is no access point (AP) to act as the central time source for the ad hoc network, the timer synchronization mechanism is completely distributed among the mobile devices of the ad hoc network. Since there is no AP, the mobile device that starts the ad hoc network will begin by resetting its TSF timer to zero and transmitting a Beacon, choosing a beacon period. This establishes the basic beaconing process for this ad hoc network. After the ad hoc network has been established, each device in the ad hoc network will attempt to send a Beacon after the target beacon transmission time (TGTT) arrives. To minimize actual collisions of the transmitted Beacon frames on the medium, each device in the ad hoc network may choose a random delay value which it may allow to expire before it attempts its beacon transmission.

Once a device has performed an inquiry that results in one or more ad hoc network descriptions, the device may choose to join one of the ad hoc networks. The joining process is a purely local process that occurs entirely internal to the mobile device. There is no indication to the outside world that a device has joined a particular ad hoc network. Joining an ad hoc network may require that all of the mobile device's MAC and physical parameters be synchronized with the desired ad hoc network. To do this, the device may update its timer with the value of the timer from the ad hoc network description, modified by adding the time elapsed since the description was acquired. This will synchronize the timer to the ad hoc network. The BSSID of the ad hoc network may be adopted, as well as the parameters in the capability information field. Once this process is complete, the mobile device has joined the ad hoc network and is ready to begin communicating with the devices in the ad hoc network.

1. Beacon

The beacon frame is a management frame that is transmitted periodically to allow mobile devices to locate and identify an ad hoc network. The beacon frame includes the fields: timestamp, beacon interval, and capability information. The timestamp contains the value of the device's synchronization timer at the time that the frame was transmitted. The capability information field is a 16-bit field that identifies the capabilities of the device. The information elements in a beacon frame are the service set identifier (SSID), the supported rates, one or more physical parameter sets, an optional contention-free parameter set, an optional ad hoc network parameter set, and an optional traffic indication map. There is no restriction on the format or content of the 32 byte SSID.

The first ad hoc device to become active establishes an IBSS and starts sending beacons that to maintain synchronization among the devices. Other ad hoc devices may join the network after receiving a beacon and accepting the IBSS parameters, such as the beacon interval, found in the beacon frame.

Each device that joins the ad hoc network may send a beacon periodically if it doesn't hear a beacon from another device within a short random delay period after the beacon is supposed to be sent. If a device doesn't hear a beacon within the random delay period, then the device assumes that no other devices are active and a beacon needs to be sent.

A beacon signal is periodically transmitted from the ad hoc network. The beacon frame is transmitted periodically and includes the address of the sending device.

2. Probe Request

The probe request frame is a management frame that is transmitted by a mobile device attempting to quickly locate a wireless LAN. It may be used to locate a wireless LAN with a particular SSID or to locate any wireless LAN. The probe request frame may contain the service attribute request. The effect of receiving a probe request is to cause the device to respond with a probe response. When a wireless device arrives within the communication range of any member of an ad hoc network, its probe request frame inquiry signals are answered by a member of the ad hoc network detecting the inquiry. A device in an ad hoc network responds to the probe request frame inquiry signals with a probe response containing the address of the responding device. The probe response frame also includes the timestamp, beacon interval, capability information, information elements of the SSID, supported rates, one or more physical parameter sets, the optional contention-free parameter set, and the optional ad hoc network parameter set.

For active scans, the WLAN radio broadcasts a probe request on the channel it is scanning using a broadcast SSID in the probe request. The WLAN radio will add any received beacons or probe responses to a cached basic service set identifier (BSSID) scan list. For passive scans, the WLAN radio does not send a probe request, but instead, listens on a channel for a period of time and adds any received beacons or probe responses to its cached BSSID scan list. The WLAN radio may scan both infrastructure and ad hoc networks, regardless of the current setting of its network mode. The WLAN radio may use either the active or passive scanning methods, or a combination of both scanning methods. When performing an active scan, the WLAN radio sets the BS SID to the broadcast MAC address in the probe request it sends. The WLAN radio performs the scan across all the frequency channels and bands that it supports.

C. Discovered Bluetooth™ Clock to Synchronize WLAN Network Activity

In example embodiments of the invention, a dual radio device having both a WLAN radio and a Bluetooth™ radio, uses its Bluetooth™ native clock to synchronize periods of WLAN network activity among participating nodes in a WLAN network. This provides a low-power enabler for network discovery and background activity of low-bandwidth, non-latency sensitive data transfer between devices participating in a WLAN network such as an ad hoc network.

The example embodiments of the invention may reduce high power consumption associated with the scanning/discovery and data transfer between devices in a WLAN ad hoc network. In a WLAN ad hoc network, there is no network timing imposed by a network master, such as a WLAN access point or a WiFi direct group owner, to synchronize activity times for data transfer opportunities. Devices in a WLAN ad hoc network usually may remain constantly active for network discovery and data transfer.

Example embodiments of the invention uses provided MAC procedures, as defined in the IEEE 802.11 specification. Example embodiments of the invention achieve sufficiently low power consumption for application in ‘always on’ or ‘background’ usage scenarios.

Example embodiments of the invention use standard Bluetooth™ discovery techniques in order to propagate timing information of WLAN ad hoc network activity periods (WLAN activity epochs) to all WLAN nodes wishing to participate. At all times other than during the WLAN activity epoch, the WLAN radio of each device is powered off. The timing of each epoch is based on a multiple of the Bluetooth™ clock rate (3.2 kHz), for example 20.48 second or 40.96 second intervals. Each epoch is a short period of activity, for example 1 second, during which nodes may participate in WLAN beacon transmission and data transfer, according to the procedures defined in the IEEE 802.11 specification.

Example embodiments of the invention have the effect of using standard Bluetooth™ and WLAN procedures and primitives to enable low-power background operations to always be on and to enable power-efficient network discovery, through a software-only implementation on any dual radio device with a WLAN and Bluetooth™ radio.

Example embodiments of the invention may be implemented by software or firmware in every device having a Bluetooth™ and WLAN radio, using the procedures and primitives defined by the Bluetooth™ standard and the WLAN standard. Moreover, example embodiments of the invention may be implemented by software or firmware in every device having a Bluetooth™ radio and a second radio operating with a Vehicle Area (WVAN) communications protocol, Wireless Video Networks (WVAN-TV) communications protocol, Personal Area (WPAN) communications protocol, Local Area (WLAN) communications protocol, or Wide Area (WAN) communications protocol, using the standard procedures and primitives defined by the respective standards. Personal Area (WPAN) communications protocols include Bluetooth BR/EDR, Bluetooth Low Energy, Wireless USB (WUSB), Ultra Wide-band (UWB), ZigBee (IEEE 802.15.4, or IEEE 802.15.4a) for short range communication between devices. Local Area (WLAN) communications protocols include digital enhanced cordless telecommunications (DECT) and HIPERLAN. Wide Area (WAN) communications protocols include Global System for Mobile Communications (GSM), General Packet Radio service (GPRS), Enhanced data rates for GSM evolution (EDGE), Evolution-Data Optimized (EV-DO), and Wideband Code Division Multiple Access (W-CDMA).

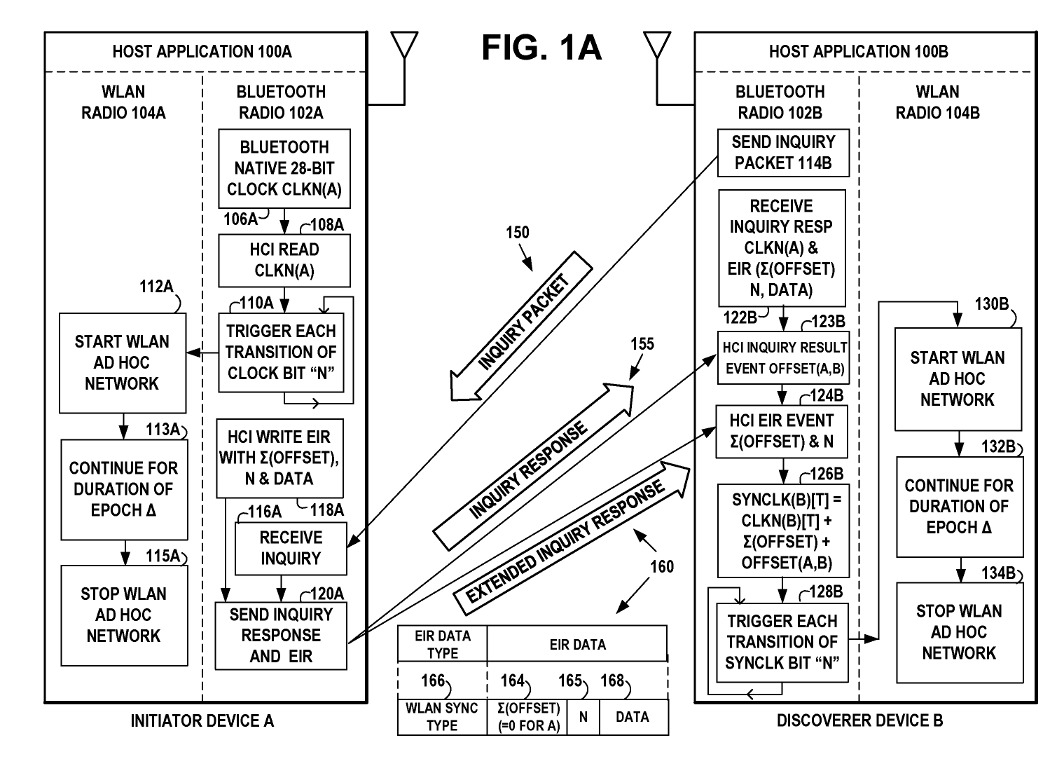

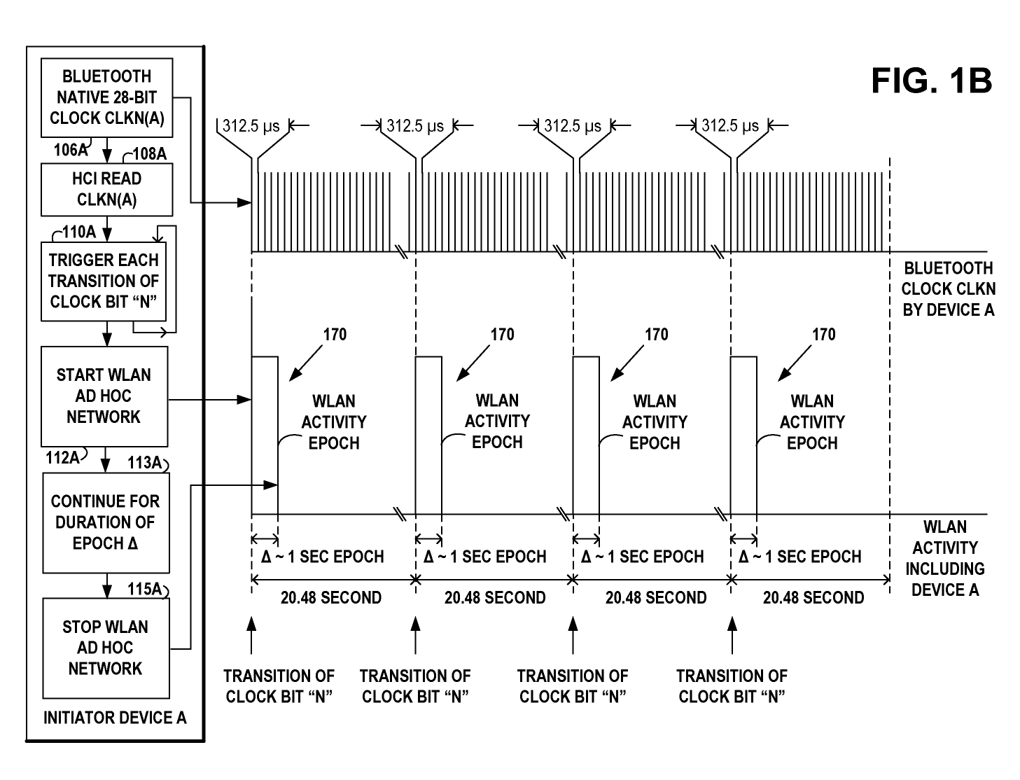

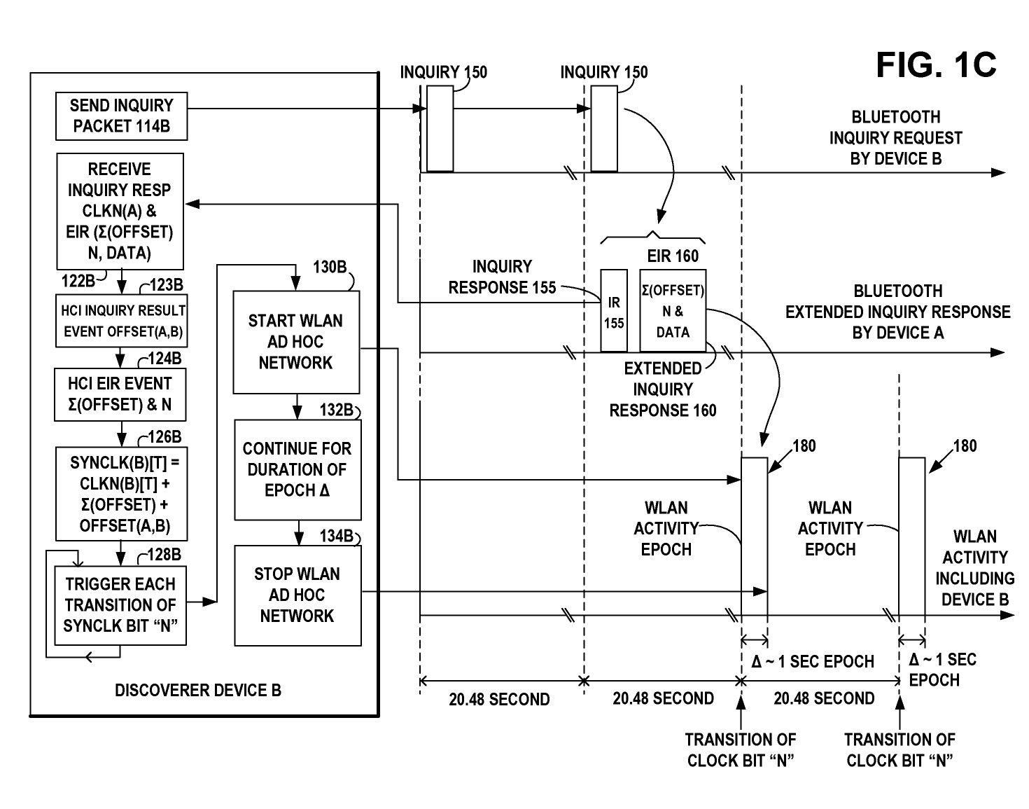

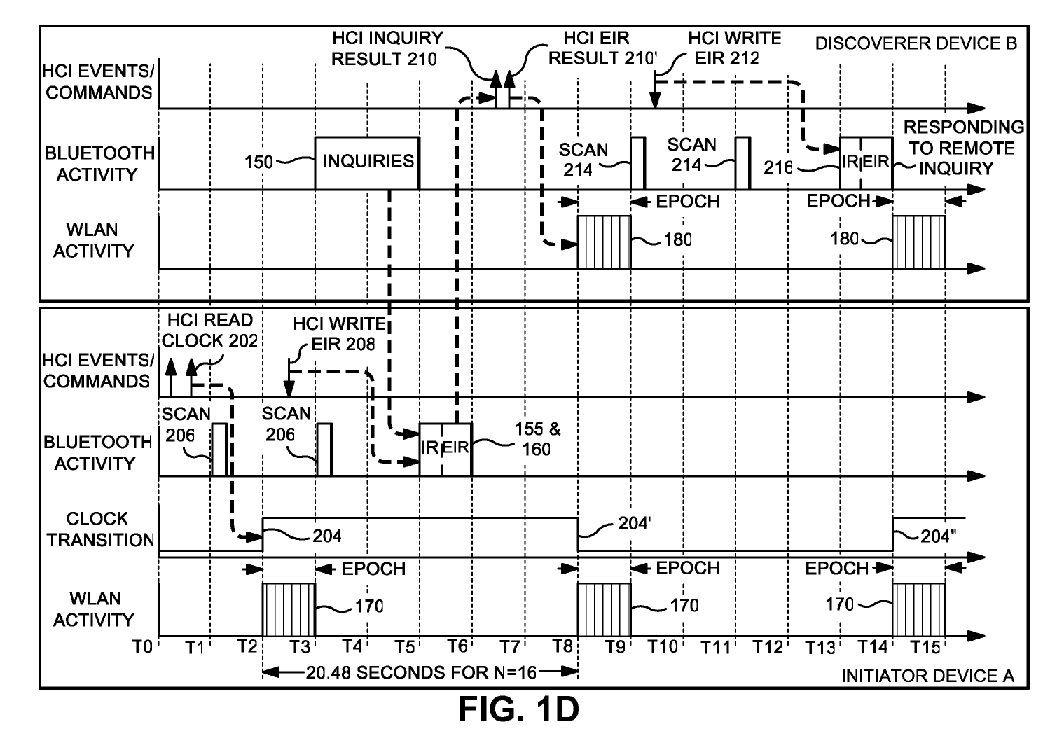

FIG. 1A, illustrates an example network diagram of an initiator apparatus or device A and a discoverer apparatus or device B, where each device is a dual radio that includes wireless short-range communication technology such as for example a Bluetooth™ radio and a WLAN radio, both controlled by a host application, in accordance with at least one embodiment of the present invention. Initiator device A includes the host application 100A that controls both the Bluetooth™ radio 102A and WLAN radio 104A. Discoverer device B includes the host application 100B that controls both the Bluetooth™ radio 102B and WLAN radio 104B.

Example embodiments of the invention synchronize instants of regular, short WLAN activity epochs to an integer (power of 2) multiple of the Bluetooth™ native clock (CLKN). This provides an efficient mechanism for WLAN network discovery using standard Bluetooth™ BR/EDR inquiry procedure that is distributed among all participating devices so that discovery of a specific device is not required to learn the WLAN network activity timing.

The Bluetooth™ radio 102A is used to indicate the periodic activation and deactivation of the WLAN radio 104A by the host application, so that each activation is a separate instance of a short-lived ad-hoc network in the WLAN protocol. The activation of the WLAN radio 104A begins at time instants based on a predetermined value of the native clock time of the Bluetooth™ radio 102A. The duration of the WLAN activation continues for a short interval or WLAN activity epoch Δ. The period of activation ends after the short interval Δ, with the deactivation of the WLAN radio 104A.

In example embodiments of the invention, the WLAN radio 104A in the initiator device A may include scanning logic. For active scans, the WLAN radio 104A may broadcast a probe request on the channel it is scanning using a broadcast SSID in the probe request. The WLAN radio may add any received beacons or probe responses to a cached BSSID scan list. For passive scans, the WLAN radio need not send a probe request, but instead, may listen on a channel for a period of time and add any received beacons or probe responses to its cached BSSID scan list. The WLAN radio may scan both infrastructure and ad hoc networks, regardless of the current setting of its network mode. The WLAN radio may use either the active or passive scanning methods, or a combination of both scanning methods. When performing an active scan, the WLAN radio sets the BS SID to the broadcast MAC address in the probe request it sends. The WLAN radio may perform the scan across all the frequency channels and bands that it supports.

In example embodiments of the invention, the Bluetooth™ radio 102A in the initiator device A includes the native clock generator 106A generating a clock value CLKN(A) derived from a free running system clock. For synchronization with other devices, offsets are used that, when added to the native clock CLKN(A), provide temporary Bluetooth™ clocks that are mutually synchronized. The native clock CLKN(A) has for example a cycle of about a day. The native clock CLKN(A) may be implemented with a 28-bit counter that wraps around at a value of 2²⁸−1 and whose least significant bit (LSB) ticks in units of 312.5 μs, giving a clock rate of 3.2 kHz.

In example embodiments of the invention, the Bluetooth™ radio 102A in the initiator device A includes the host controller interface that provides a command interface between the host application 100A in the device A and the link layer of the Bluetooth™ radio 102A, to enable access to hardware status and control registers of the Bluetooth™ radio. The host controller interface includes the standard HCI read clock command logic 108A that reads the current value of the Bluetooth™ native clock CLKN(A) from the clock generator 106A. The 28-bit value of native clock CLKN(A) is incremented at the 3.2 kHz rate with the 312.5 μs period between increments.

In example embodiments of the invention, the host application 100A is programmed to monitor the current value of native clock CLKN(A) with host logic 110A, for when the transition of bit N (CLKNN) occurs for native clock CLKN(A). For example, if N=16, the transition occurs at the instant when a 20.48 second interval is completed (corresponding to 312.5 μs×2¹⁶), the predetermined interval being referred to herein as clock CLKN16. In other words, N is equal to the value of the logarithm to base two of the predetermined interval CLKN16 of the native clock time, minus a value of one.

The transition of bit N occurs periodically, with a period of 20.48 seconds. Every time the transition occurs, the host application logic 110A provides a trigger indication to host logic 112A to start the WLAN ad hoc network activity. The WLAN ad hoc network activity will continue for the fixed duration of the WLAN activity epoch Δ 170 shown in FIG. 1B, as specified by the host logic 113A. At the expiration of the duration of the WLAN activity epoch Δ, host logic 115A stops the WLAN network activity, as shown in FIG. 1B.

The host logic 113A sets a timer for the MAC to begin WLAN beaconing at the estimated CLKNN transition. WLAN ad hoc network activity occurs during the WLAN activity epochs 170 shown in FIG. 1B. At all times other than the WLAN activity epoch, the WLAN radio of each device may be powered off. Collision avoidance may be handled entirely within the IEEE802.11 protocol, hence the trigger event itself does not need to include a random delay.

FIG. 1B illustrates an example timing diagram of the initiator apparatus or device A of FIG. 1A, showing an example relationship between the Bluetooth™ native clock CLKN(A) of the Bluetooth™ radio 102A and the WLAN activity of the WLAN radio 104A, in accordance with at least one embodiment of the present invention. The native clock CLKN(A) ticks generated by the Bluetooth™ clock generator 106A are shown in units of 312.5 μs, giving them a clock rate of 3.2 kHz. The HCI read clock command logic 108A reads the current value of the Bluetooth™ native clock CLKN(A) from the clock generator 106A. The timing of the trigger transition by Host logic 110A to trigger host logic 112A to start the WLAN activity, is based on a multiple of the Bluetooth™ 3.2 kHz clock rate. Each WLAN activity epoch 170 of WLAN activity is a short period of activity, for example 1 second, during which several beacon periods containing data frames may be transmitted by the WLAN radio 104A. The host logic 113A sets the duration value Δ for the duration of the WLAN activity epoch 170. At all times other than during the WLAN activity epoch 170, the host logic 115A may cause the WLAN radio to be powered off.

FIG. 1C illustrates an example timing diagram of the discoverer apparatus or device B of FIG. 1A, showing the transmitting of example Bluetooth™ BR/EDR inquiry request packets 150 broadcast by the send inquiry packet logic 114B of the discoverer device B. FIGS. 1A and 1C show receiving example Bluetooth™ extended inquiry response packets 160 by the receive logic 122B of the discoverer device B, that were broadcast by send logic 120A of initiator device A of FIG. 1A. FIG. 1C shows the resulting synchronized WLAN activity epochs 180 of duration Δ started by the start WLAN logic 130B of the WLAN radio of discoverer device B. The resulting synchronized WLAN activity epochs 180 of the WLAN radio of discoverer device B, are synchronized with the WLAN activity epochs 170 of the WLAN radio of initiator device A, in accordance with example embodiments of the invention.

In example embodiments of the invention, the Bluetooth™ radio 102B in the discoverer device B of FIG. 1A, transmits inquiry request packets 150 with inquiry logic 114B of FIGS. 1A and 1C, using the general or dedicated inquiry access code (IAC). The inquiry hopping rate is 3200 hops per second, transmitting inquiry request packets 150 and listening for inquiry responses 155 over 16 different hopping frequencies in the inquiry-hopping sequence, over a period of 10 milliseconds. If an insufficient number of inquiry responses 155 is received, discoverer device B may repeat the same process at least 256 times, for up to 2.56 seconds.

In example embodiments of the invention, the Bluetooth™ radio 102A in the initiator device A, the inquiry scanning logic 116A of FIG. 1A, performs an inquiry scan procedure to listen for inquiry request packets 150 received on its inquiry scan physical channel. The inquiry scanning logic 116A uses one of its inquiry scan channels and remains passive on that channel until it receives an inquiry request packet 150 on this channel from another Bluetooth™ device. This is identified by the appropriate inquiry access code (IAC). The inquiry scanning logic 116A may scan for the inquiry access code long enough to completely scan for 16 inquiry frequencies. When an inquiry request packet 150 is received, the inquiry scanning logic 116A will then pass control to the send inquiry response and EIR 120A of FIG. 1A.

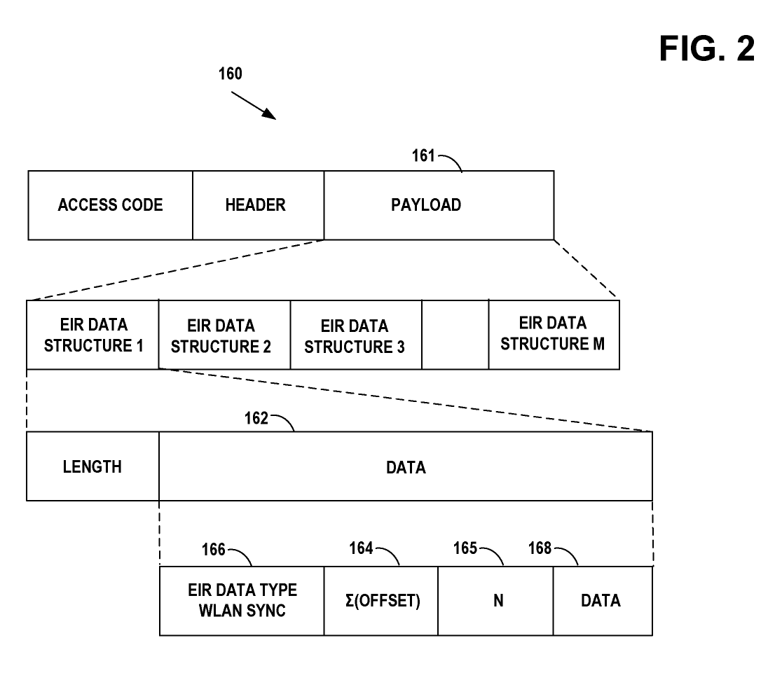

In example embodiments of the invention, the Bluetooth™ radio 102A in the initiator device A, the standard HCI write extended inquiry response (EIR) logic 118A of FIG. 1A, performs the Write_Extended_Inquiry_Response command to write the data content of the extended inquiry response packet 160 to be sent during the extended inquiry response procedure. FIG. 2 is an example of the Bluetooth™ EIR packet 160 that includes an EIR data type 166 that designates it as a WLAN beacon synchronization type, in accordance with example embodiments of the invention.

In example embodiments of the invention, in the Bluetooth™ radio 102A in the initiator device A, the host logic 120A of FIG. 1A, forwards inquiry response packet 155 and the extended inquiry response packet 160 to the baseband medium access control and physical radio for broadcast transmission by the Bluetooth™ radio 102A. The clock CLK₂₇₋₂ in the FHS inquiry response packet 155 is a 26-bit field that contains the value of the native clock CLKN(A), sampled at the beginning of the transmission of the access code of this FHS packet. This clock value has a resolution of 1.25 ms (two-slot interval). For each new transmission, this field is updated so that it accurately reflects the real-time clock value of native clock CLKN(A).

In example embodiments of the invention, the Bluetooth™ radio 102B in the discoverer device B, includes the inquiry response scanning logic 122B of FIGS. 1A and 1C, that receives an initial inquiry response packet 155 at the hop frequency of the inquiry message 150. The initial inquiry response packet 155 is an FHS packet that contains the initiator device A's device address (BD_ADDR), the native clock CLKN(A), and other parameters. The initial inquiry response packet 155 has the extended inquiry response bit set to one, indicating that the extended inquiry response packet 160 follows. Control is then passed to the HCI inquiry result event logic 123B and the HCI EIR event logic 124B of FIGS. 1A and 1C.

In example embodiments of the invention, the Bluetooth™ radio 102B in the discoverer device B, the standard HCI inquiry result event logic 123B of FIGS. 1A and 1C, performs the HCI Inquiry Result event procedure to extract the native clock CLKN(A) from the packet. The inquiry result event indicates that a remote device has responded with an inquiry response (IR) packet 155 during the current inquiry process. The event parameters may be sent by the HCI inquiry result event procedure to the host application 100A as soon as the inquiry response 155 is received. The event parameters include BD_ADDR and Class_of_Device of the remote device and Clock_Offset OFFSET(A,B) between the responding device A and the inquiring device B.

In example embodiments of the invention, the Bluetooth™ radio 102B in the discoverer device B, the standard HCI EIR event logic 124B of FIGS. 1A and 1C, performs the HCI extended inquiry result event procedure to extract the data from the received extended inquiry response packet 160 and to send this data to the host application 100B. The received data may be passed unaltered to the host application 100B, if it has been correctly received. The EIR data extracted from the packet 160 includes the accumulated sum, Σ(OFFSETs), 164, of the offsets from prior devices in a sequence starting with the initiator device A. In the case of the initiator device, itself, the value of Σ(OFFSETs) may be zero. The EIR data extracted from the packet also includes the transition bit N for native clock CLKN(A), 165. For example, if the transition bit N=16, the transition occurs at the instant when a 20.48 second interval is completed (corresponding to 312.5 μs×2¹⁶). The EIR data extracted from the packet may also include WLAN data 168 that provides additional information about the IBSS network of the initiator device A, such as the IBSS SSID, channel information. In example embodiments of the invention, the WLAN data 168 may also include the duration of the WLAN activity epoch.

In example embodiments of the invention, the Bluetooth™ radio 102B in the discoverer device B, the host application logic 126B of FIGS. 1A and 1C, is programmed to compute a current value at time T for the synchronization clock SYNCLK(B)[T] that is a replica of the current value at time T of the native clock CLKN(A)[T] initiator device A. The value of SYNCLK(B)[T] at any time T in device B is approximately the same value as the native clock CLKN(A)[T] initiator device A. The value of SYNCLK(B)[T] is expressed as:

SYNCLK(B)[T]=CLKN(B)[T]+Σ(OFFSET)+OFFSET(A,B) [Eqn. 1]
where:
CLKN(B)[T] is the value at time T of the native clock CLKN(B)[T] of the discoverer device B;
Σ(OFFSET) is the accumulated sum of the offsets from prior devices in a sequence starting with the initiator device A; and
OFFSET(A,B) is the offset between the immediately responding device A and the inquiring device B.

The value of CLKN(B)[T] is obtained by the HCI read clock command that reads the current value at time T of the Bluetooth™ native clock CLKN(B) in device B.

The value of OFFSET(A,B) is the Clock_Offset value obtained by the HCI inquiry result event procedure extracting CLKN(A)[T] from the received inquiry response 155 of the immediately responding device A and providing the offset between the immediately responding device A and the inquiring device B.

The value of Σ(OFFSET) is a miming accumulation of the Clock_Offset values obtained by the HCI inquiry result event procedure in prior devices in a sequence starting with the initiator device A. The value of Σ(OFFSET) is included in the extended inquiry response 160 of the immediately responding device A, the running accumulation having been stored in the memory of the immediately responding device A. In the case of the initiator device A, itself, the value of Σ(OFFSETs) is zero.

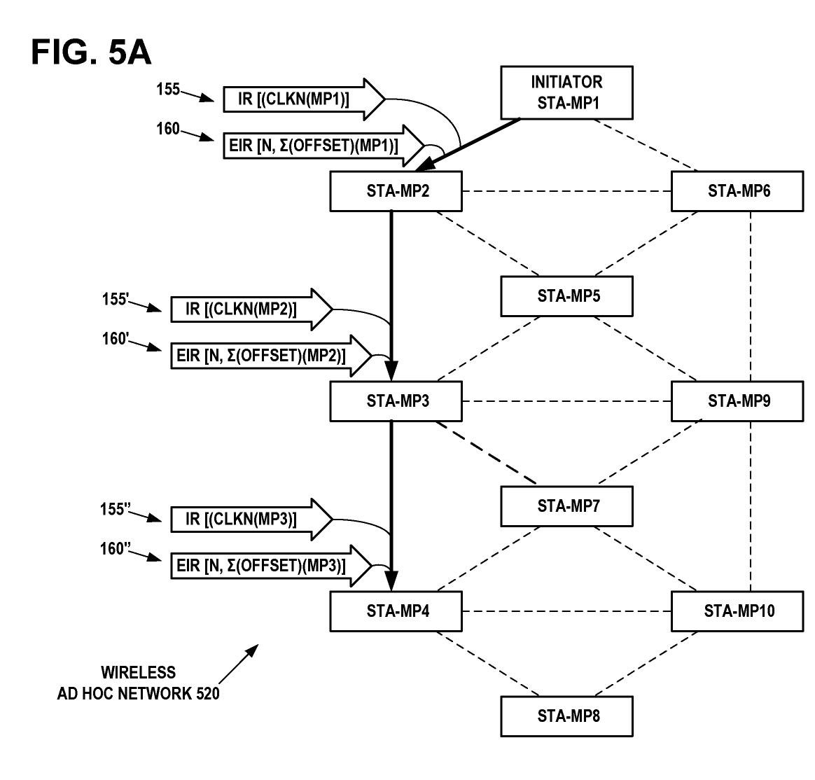

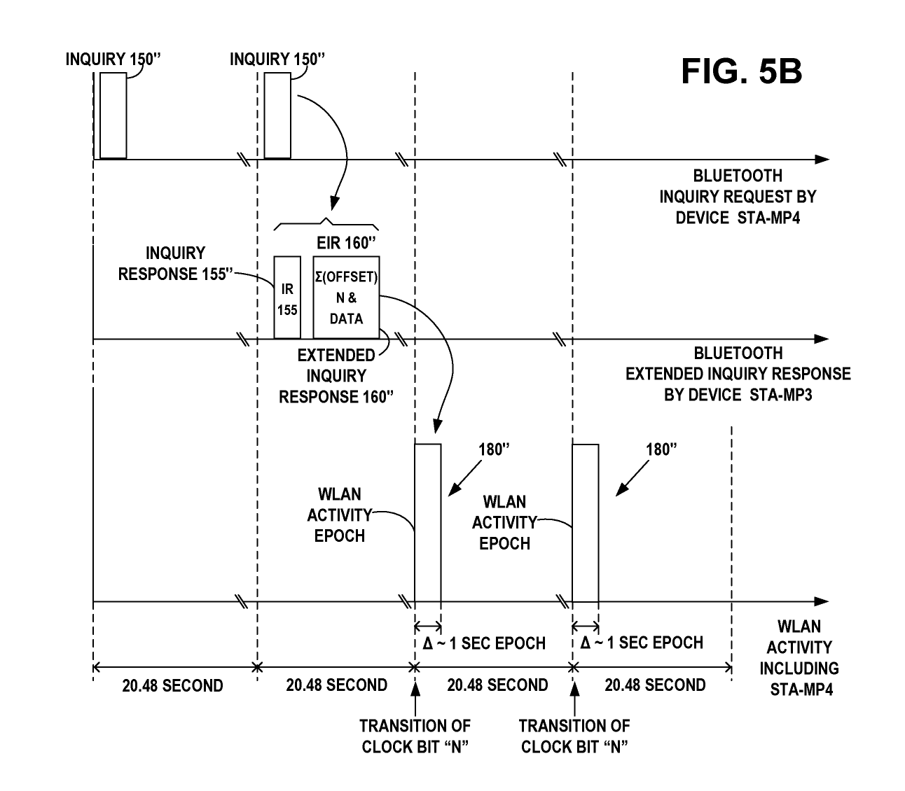

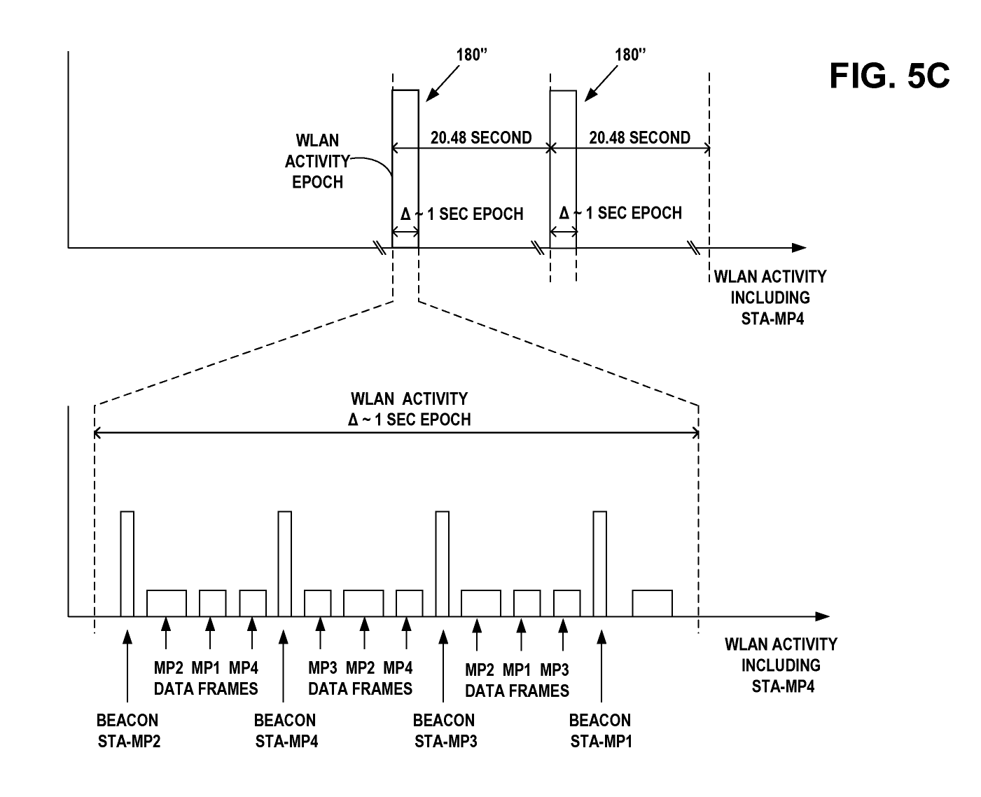

FIG. 1C shows the resulting synchronized WLAN activity epochs 180 of the WLAN radio of discoverer device B, which are synchronized with the WLAN activity epochs 170 of the WLAN radio of initiator device A, in accordance with example embodiments of the invention. FIG. 5C shows an example detailed illustration of an example of the beacons and data frames transmitted during one WLAN activity epoch of duration Δ of approximately one second duration. The devices in the wireless ad hoc network have been synchronized using native clock timing of the Bluetooth™ native clock CLKN of the Bluetooth™ radio to synchronize the WLAN activity of the WLAN radio of the network, in accordance with at least one embodiment of the present invention.

An example software implementation for embodiments of the invention may include an operating system, for example, Symbian operating system, to implement HCI commands:
1. CReadClock: public CHCICommandBase;
2. CWriteExtendedInquiryResponseCommand: public CHCICommandBase;
3. TExtendedInquiryResultEvent&TExtendedInquiryResultEvent::Cast(constTHCIE ventBase&aEvent); and
4. Start/Stop IBSS WLAN API.

Another example software implementation for embodiments of the invention may include an operating system, for example, the Linux operating system, to implement HCI commands. Linux Bluetooth subsystem includes several layers: Bluetooth Core (HCI device and connection manager, scheduler) and HCI Device drivers (Interface to the hardware). BlueZ is the canonical Bluetooth stack for Linux to make an implementation of the Bluetooth wireless standards specifications for Linux.

FIG. 1D illustrates a more detailed example timing diagram of an initiator device A and a discoverer device B, where each device is a dual radio that includes wireless short-range communication technology such as for example a Bluetooth™ radio and a WLAN radio, showing an example relationship between the Bluetooth™ host controller interface events and commands, Bluetooth activity, and WLAN activity, including the transmitting of example Bluetooth™ inquiry request packets broadcast by the discoverer device B, showing the receiving of example Bluetooth™ extended inquiry response packets that were broadcast by initiator device A, and showing the resulting synchronized WLAN activity of the devices A and B, in accordance with at least one embodiment of the present invention.

In the initiator device A of FIG. 1D, the Bluetooth HCI read clock command 202 is shown occurring, for example, between times T0 and T1. The HCI read clock command 202 is repeated periodically to keep an updated value of the Bluetooth native clock CLKN(A). If the transition bit N=16, the clock transition 204 occurs at the instant when a 20.48 second interval is completed, at time T2. Periodic clock transitions are shown as transition 204 at time T2, as transition 204′ at time T8, and as transition 204″ at time T14.

Bluetooth passive scanning 206 of FIG. 1D, is periodically conducted by the initiator device A, for example at times T1 and T3, to detect any inquiry requests from other Bluetooth devices.

The HCI write EIR command 208 of FIG. 1D, is shown occurring, for example, between times T2 and T3, which writes the data into the Bluetooth EIR packet 160 shown in FIG. 2. The data written into the EIR packet 160 includes the accumulated sum, Σ(OFFSETs), 164, the transition bit N, 165, and WLAN data 168.

The discoverer device B of FIG. 1D, periodically transmits during inquiries period inquiry requests 150, shown for example between the times T3 and T5.

The passive scanning 206 conducted by the initiator device A of FIG. 1D, detects one or more of the inquiry requests 150 at T5 from the discoverer device B.

In response, the initiator device A of FIG. 1D, transmits at time T6, the inquiry response packet 155 that includes the current value of the native clock CLKN(A) and initiator device A transmits the extended inquiry response packet 160 that includes the accumulated sum, Σ(OFFSETs), 164, the transition bit N, 165, and WLAN data 168 as shown in FIG. 2.

The discoverer device B of FIG. 1D, performs the HCI inquiry result event 210 that sends to its host the event parameters including Clock_Offset, OFFSET(A,B), between the initiator device A and the discoverer device B.

The discoverer device B of FIG. 1D, also performs the HCI extended inquiry result event 210′ that sends to its host as the event parameters the accumulated sum, Σ(OFFSETs), 164, the transition bit N, 165, and WLAN data 168.

The host logic computes the current clock value SYNCLK(B)[T]=CLKN(B)[T]+Σ(OFFSET)+OFFSET(A,B) and monitors when the transition of bit N occurs for SYNCLK(B)[T]. When the transition occurs, the host application logic provides a trigger indication to start the WLAN ad hoc network activity 180 at time T8 of FIG. 1D. WLAN ad hoc network activity 180 of discoverer device B is synchronized with WLAN activity epoch 170 of initiator device A.

The discoverer device B of FIG. 1D, may periodically conduct Bluetooth passive scanning 214, for example at times T9 and T11, to detect any inquiry requests from other Bluetooth devices.

The HCI write EIR command 212 of FIG. 1D, is shown occurring, for example, between times T9 and T10, which writes the data into the Bluetooth EIR packet 160 shown in FIG. 2.

The passive scanning 214 conducted by the discoverer device B of FIG. 1D, detects one or more inquiry requests from a remote device at T13.

In response, the discoverer device B of FIG. 1D, transmits at time T13, the inquiry response packet and extended inquiry response packet 216 of FIG. 1D.

In an example synchronization procedure, initiator device A of FIG. 1A, may perform the following steps:

1. Use HCI_Read_Clock(Local Clock) to Read local Bluetooth™ radio clock (CLKN). (Allow for estimated software delay between native clock CLKN and HCI result event handling by the Bluetooth™ Host controller; probably of the order of 1-2 native clock CLKN cycles).

2. Activate Bluetooth™ inquiry.

3. Inquiry result does not report any existing suitable WLAN network interval timing (or SSID does not match, etc.).

4. Set timer to activate WLAN radio and begin WLAN IBSS beaconing at estimated CLKNN transition (N=16 for example=20.48 s interval). (Allow for estimated software delay as mentioned above.)

5. Use HCI_Write_Extended_Inquiry_Response command to format Extended Inquiry Response packet containing:
the value of N;
the accumulated sum, Σ(OFFSETs)(A); (zero may be used for the initiator device A)
WLAN network information (IBSS SSID, channel info, etc.); and
Optional use manufacturer specific data types.

6. Bluetooth™ local radio continues in inquiry scan (discoverable) state.

7. At expiry of timer set in step 4, activate WLAN radio and begin WLAN IBSS beaconing for fixed interval (e.g. for 1 second with beacon interval of 100 ms). (Timer expiry instant is equal to the time defined by next CLKNN transition.)

In an example synchronization procedure, discoverer device B of FIG. 1A, wishes to start or join a wireless ad hoc network, such as a mesh network, and may perform the following steps:

1. Use HCI_Read_Clock (Local Clock) to Read local Bluetooth™ native clock (CLKN).

(Allow for estimated software delay between native clock CLKN and HCI result event handling by the Bluetooth™ Host controller, probably of the order of 1-2 native clock CLKN cycles.)

2. Activate local Bluetooth™ inquiry.

3. Inquiry result finds Device A (and possibly others). HCI inquiry result event and HCI EIR event contain:
Bits 16-2 CLKN offset between device A and device B, i.e., OFFSET(A,B);
Value of N (included in EIR packet from device A);
the accumulated sum, Σ(OFFSETs)(A); (zero may be used from the initiator device A)
and
WLAN network information (SSID, channel, etc.).

4. Use HCI_Write_Extended_Inquiry_Response command to format own EIR packet containing:
the value of N;
the accumulated sum, Σ(OFFSETs)(B); (=OFFSET(A,B) for device B)
WLAN network information (IBSS SSID, channel info, etc.)
May use manufacturer specific data types

5. Activate WLAN radio and begin participating in WLAN ad hoc (IBSS) beaconing at epoch defined by Bluetooth™ clock bit transition denoted by:

SYNCLK(B)[T]=CLKN(B)[T]+Σ(OFFSET)(A)+OFFSET(A,B).
Use WLAN channel, SSID info as received in EIR packet from device A to configure WLAN ad hoc network.

6. Note if several participating devices discovered by device B, may use aggregate estimate, for example average, for W-CLKNB value and thereby average out rounding and/or truncation error.

In example embodiments of the invention, the EIR data type of the extended inquiry response packet 160 of FIG. 2 is a WLAN synchronization type. FIG. 2 illustrates an example modification, in accordance with embodiments of the invention, of the standard format for the Bluetooth™ extended inquiry response packet 160, as described for example in the Bluetooth™ Core Specification, Version 4.0. The extended inquiry response packet 160 includes an EIR data type that designates it as a WLAN synchronization type, in accordance with example embodiments of the invention. The payload data 161 is 240 octets and has two parts, a significant part followed by a non-significant part. The significant part contains a sequence of data structures 162. The non-significant part contains all zero octets. Each data structure 162 will have a length field of one octet, which contains the length value, and a data field of Length octets. The first n octets of the data field 162 contain the extended inquiry response (EIR) data type 166. The content of the remaining EIR data has a length of the number of octets in the data field and depends on the value of the EIR data type and is called the EIR data. The non-significant part extends the extended inquiry response to 240 octets and will contain all-zero octets. EIR data types 166 may include at least one of service class universally unique identifier (QUID), local name, flag bits, manufacturer specific data, transmission power level, and secure simple pairing out of band (OOB).

In example embodiments of the invention, the EIR data type 166 of the extended inquiry response packet 160 of FIG. 2 designates it as a WLAN synchronization type. The EIR data written into the packet 160 as EIR data includes the accumulated sum, Σ(OFFSETs), 164, of the offsets from prior devices in a sequence starting with the initiator device A. In the case of the initiator device, itself, the value of Σ(OFFSETs) may be zero. The EIR data written into the packet also includes the transition bit N for native clock CLKN(A), 165. For example, if the transition bit N=16, the transition occurs at the instant when a 20.48 second interval is completed (corresponding to 312.5 μs×2¹⁶). The EIR data written into the packet also includes WLAN data 168 that provides additional information about the IBSS network of the initiator device A, such as the IBSS SSID, channel information. In example embodiments of the invention, the WLAN data 168 may also include the duration Δ of the WLAN activity epoch.

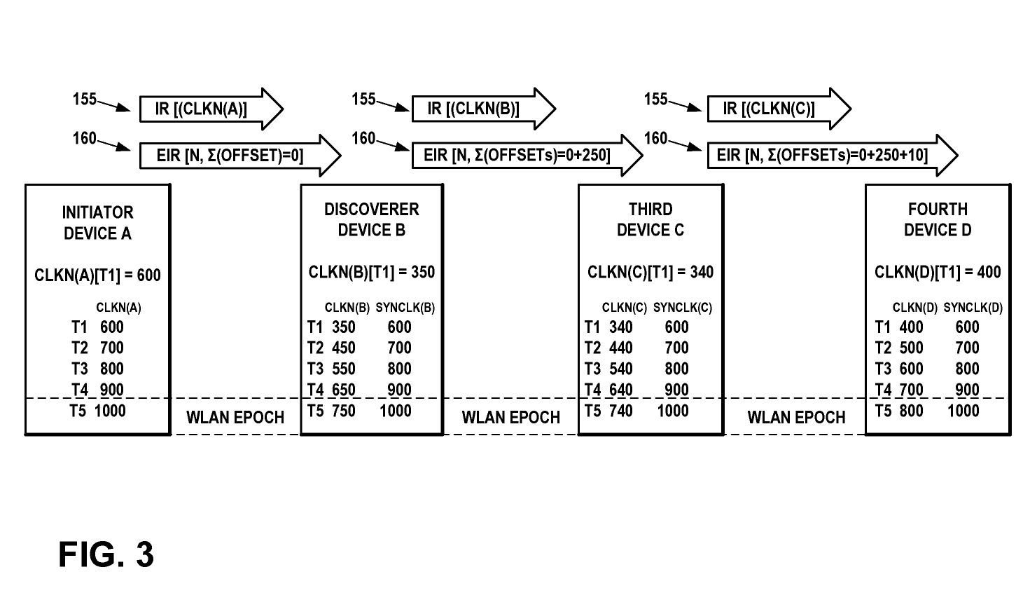

FIG. 3 illustrates an example of using the synchronization clock SYNCLK(B)[T] to synchronize four devices in an ad hoc network that includes the initiator device A and the discoverer device B of FIG. 1A and two additional devices C and D similar to devices A and B. The figure illustrates an example of synchronized WLAN activity of the WLAN radio of the four devices in the ad hoc network, resulting from each of the devices B, C, and D replicating the current value the native clock CLKN(A) of the initiator device A, in accordance with at least one embodiment of the present invention. To facilitate the discussion of this example, the clock values are given in decimal numbers, instead of binary numbers.

FIG. 3 shows the initiator device A using the HCI read clock command to read the current value of the Bluetooth™ native clock CLKN(A) at sequential times T, as in Table 1:

TABLE 1

| Time T | CLKN(A) |
|---|---|
| T1 | 600 |
| T2 | 700 |
| T3 | 800 |
| T4 | 900 |
| T5 | 1000 |

In this example, the decimal value of native clock CLKN(A)=1000 at time T5 is attributed as the transition value, analogous to the binary value of native clock CLKN(A) when the transition of bit N occurs, as previously discussed.

FIG. 3 shows the initiator device A transmitting to the discoverer device B an inquiry response packet 155 containing the native clock CLKN(A) at various times T. An accompanying extended inquiry response packet 160 contains the value for N and a value of “0” for Σ(OFFSET). HCI inquiry result event computes the Clock_Offset value of 250 for OFFSET(A,B) between device A device B and sends it as an event parameter to the Host.

FIG. 3 shows the discoverer device B using Equation 1 to compute SYNCLK(B)[T] at sequential times T, as shown in Table 2:

TABLE 2

| Time T | CLKN(B) | SYNCLK(B) |
|---|---|---|
| T1 | 350 | 600 |
| T2 | 450 | 700 |
| T3 | 550 | 800 |
| T4 | 650 | 900 |
| T5 | 750 | 1000 |

Note that the values of SYNCLK(B)[T] in device B track the respective values of native clock CLKN(A) in the initiator device A. The value of SYNCLK(B)[T] at any time T in device B is approximately the same value as the native clock CLKN(A)[T] wireless initiator device A. At time T5, SYNCLK(B)[T5]=CLKN(B)[T5]+Σ(OFFSET)+OFFSET(A,B)=750+0+250=1000. The decimal value of SYNCLK(B)[T5]=1000 at time T5, which is attributed as the transition value.

Similarly, FIG. 3 shows the device B transmitting to the third device C an inquiry response packet 155 containing the native clock CLKN(B) at various times T. An accompanying extended inquiry response packet 160 contains the value for N and the value of “0+250” for Σ(OFFSET). HCI inquiry result event computes the Clock_Offset value of 10 for OFFSET(B,C) between device B device C and sends it as an event parameter to the Host.

FIG. 3 shows the third device C using Equation 1 to compute SYNCLK(C)[T] at sequential times T, as shown in Table 3:

TABLE 3

| Time T | CLKN(C) | SYNCLK(C) |
|---|---|---|
| T1 | 340 | 600 |
| T2 | 440 | 700 |
| T3 | 540 | 800 |
| T4 | 640 | 900 |
| T5 | 740 | 1000 |

Note that the values of SYNCLK(C)[T] in device C track the respective values of native clock CLKN(A) in the initiator device A. The value of SYNCLK(C)[T] at any time T in device C is approximately the same value as the native clock CLKN(A)[T] wireless initiator device A. At time T5, SYNCLK(C)[T5]=CLKN(C)[T5]+Σ(OFFSET)+OFFSET(B,C)=740+0+250+10=1000. The decimal value of SYNCLK(C)[T5]=1000 at time T5, which is attributed as the transition value.

Similarly, FIG. 3 shows the third device C transmitting to the fourth device D an inquiry response packet 155 containing the native clock CLKN(C) at various times T. An accompanying extended inquiry response packet 160 contains the value for N and the value of “0+250+10” for Σ(OFFSET). HCI inquiry result event computes the Clock_Offset value of −60 for OFFSET(C,D) between device C and device D and sends it as an event parameter to the Host.

FIG. 3 shows the fourth device D using Equation 1 to compute SYNCLK(D)[T] at sequential times T, as shown in Table 4:

TABLE 4

| Time T | CLKN(D) | SYNCLK(D) |
|---|---|---|
| T1 | 400 | 600 |
| T2 | 500 | 700 |
| T3 | 600 | 800 |
| T4 | 700 | 900 |
| T5 | 800 | 1000 |

Note that the values of SYNCLK(D)[T] in device D track the respective values of native clock CLKN(A) in the initiator device A. The value of SYNCLK(D)[T] at any time T in device D is approximately the same value as the native clock CLKN(A)[T] wireless initiator device A. At time T5, SYNCLK(D)[T5]=CLKN(D)[T5]+Σ(OFFSET)+OFFSET(C,D)=800+0+250+10−60=1000. The decimal value of SYNCLK(D)[T5]=1000 at time T5, which is attributed as the transition value.

The host application logic 126B of FIGS. 1A and 1C, calculates SYNCLK(B)[T] and provides it to host application logic 128B to monitor when the transition of bit N periodically occurs for SYNCLK(B)[T]. The transition of bit N occurs periodically, with a period of 20.48 seconds. Every time the transition occurs, the host application logic 128B provides a trigger indication to host logic 130B to start the WLAN ad hoc network activity. The WLAN ad hoc network activity will continue for the fixed duration Δ of the WLAN activity epoch 180 shown in FIG. 1C, as specified by the host logic 132B. At the expiration of the duration of the WLAN activity epoch Δ, host logic 134B stops the WLAN ad hoc network activity, as shown in FIG. 1C.

Host logic 130B in the WLAN radio 104B of the discoverer device B of FIGS. 1A and 1C, causes the WLAN radio 104B to start sending IBSS beacon frames and data frames. Logic 132B of FIGS. 1A and 1C, continues the WLAN activity for a fixed interval WLAN activity epoch 180 of duration Δ that is synchronized with the WLAN activity epoch 170 generated by the initiator device A. The logic 132B of FIGS. 1A and 1C, sets a timer to begin WLAN IBSS beaconing at the computed transition time. For example, if N=16, then the interval between consecutive WLAN activity epochs 180 is 20.48 seconds. WLAN ad hoc network activity occurs during the epochs 180 of duration Δ and are synchronized with the WLAN activity epochs 170 generated by the initiator device A. At all times other than the WLAN activity epoch, may stop WLAN ad hoc network logic 134B of FIGS. 1A and 1C, causes the WLAN radio 104B to be powered off.

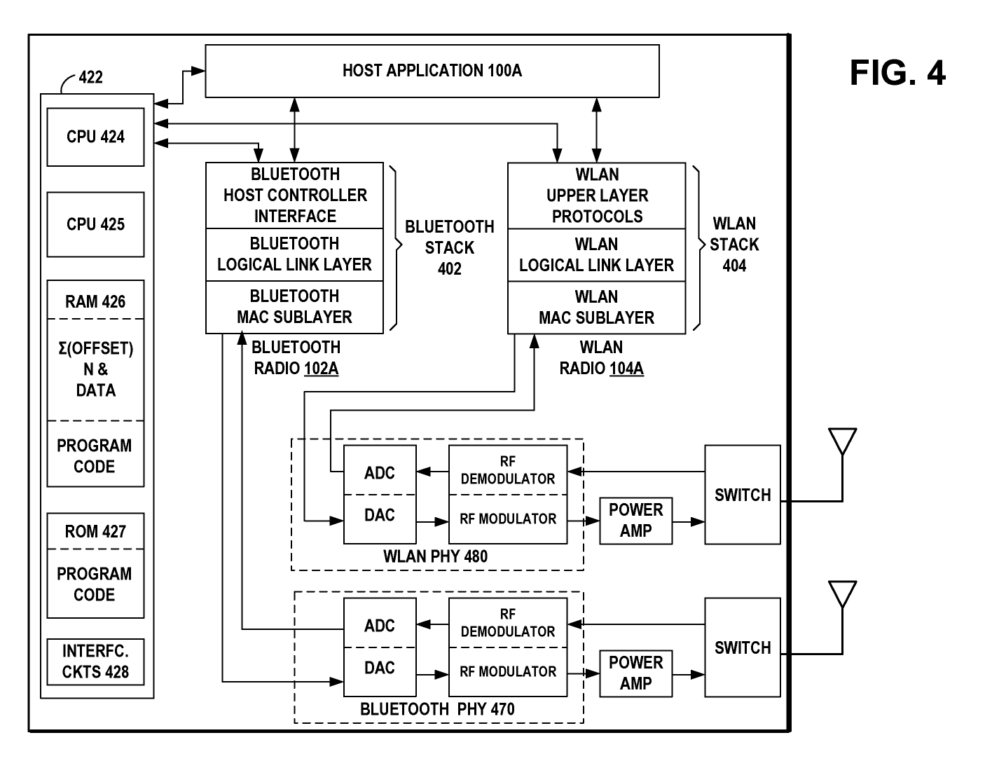

FIG. 4 is an example functional block diagram of the initiator device A and the discoverer device B of FIG. 1A, in accordance with at least one embodiment of the present invention. FIG. 4 is an example embodiment of the initiator device A of FIG. 1A, comprising an example dual radio embodiment with a first and a second wireless communications protocol like the Bluetooth radio 102A and the WLAN radio 104A. The Bluetooth protocol stack 402 in the Bluetooth radio 102A, in example embodiments, may include Bluetooth HCI upper layer protocols, Bluetooth logical link layer, and Bluetooth MAC sublayer. The WLAN protocol stack 404 in the WLAN radio 104A, in example embodiments, may include WLAN upper layer protocols, WLAN logical link layer, and WLAN MAC sublayer. Each protocol stack 402 and 404 may have its respective digital baseband transmission path outputting its signal to the respective physical layer (PHY) radio 470 or 480. On the receive side, the respective radio 470 or 480 outputs the received signal to the digital baseband transmission path of the respective protocol stack 402 and 404, according to an embodiment of the present invention. The initiator device A and a wireless device B may have the same types of components.

The example Bluetooth protocol stack 402 in example embodiments may have the digital baseband transmission path of the Bluetooth MAC sublayer output the digital baseband signal through PHY logic to a digital-to-analog converter and transmitter of an example radio frequency (RF) radio 470. The modulated output of the RF radio 470 may be amplified by a power amplifier (AMP) and applied to a transmit/receive switch and the antenna of the Bluetooth link. In receiving signals on the antenna of the Bluetooth link, the transmit/receive switch passes the RF signal to the receiver of the RF radio 470 and an analog-to-digital converter. The demodulated digital baseband signal then passes through PHY layer logic to the Bluetooth MAC sublayer of the Bluetooth protocol stack 402.

The example WLAN protocol stack 404 in example embodiments may have the digital baseband transmission path of the WLAN MAC sublayer output the digital baseband signal through PHY logic to a digital-to-analog converter and transmitter of an example RF radio 480. The modulated output of the RF radio 480 may be amplified by a power amplifier and applied to a transmit/receive switch and the antenna of the IEEE 802.11 WLAN link. In receiving signals on the antenna of the WLAN link, the transmit/receive switch passes the RF signal to the receiver of the RF radio 480 and an analog-to-digital converter. The demodulated digital baseband signal then passes through PHY layer logic to the WLAN MAC sublayer of the WLAN protocol stack 404 for example IEEE 802.11.

In an example embodiment of the invention, the WLAN and Bluetooth antennas may be realized by a common antenna that is shared by both radios. The PHY layer logic of the WLAN and Bluetooth radios may be implemented by a shared PHY layer logic.

The initiator device A and the discoverer device B of FIG. 1A include a processor 422, which may include a single core CPU or multiple core central processing unit (CPU) 424 and 425, a random access memory (RAM) 426, a read only memory (ROM) 427, and interface circuits 428 to interface with one or more radio transceivers, battery or house power sources, keyboard, display, key pad, touch screen, display, microphone, speakers, ear pieces, camera or other imaging devices, etc. The RAM and ROM can be removable memory devices such as smart cards, SIMs, WIMs, semiconductor memories such as RAM, ROM, PROMS, flash memory devices, etc.

An example embodiments of the host application 100A, HCI upper layer protocols, the Bluetooth stack 402, the WLAN upper layer protocols, and/or the WLAN stack 404 may be computer program code instructions stored in the RAM 426 and/or ROM 427 memory of the processor 422, which when executed by the central processing units (CPU) 424 and or 425, carry out the functions of the example embodiments of the invention. Alternately, some or all of these instructions may be embodied as hardware program logic included in programmed logic arrays of sequential and/or combinatorial logic circuits and/or state machine logic implementing some or all of the steps performed by embodiments of the invention.

D. Discovered Bluetooth™ Clock to Synchronize Ad Hoc Networks

Example embodiments of the invention may be applied to wireless ad hoc networks, to propagate synchronization among the devices in the ad hoc network such as for example in a mesh network, wherein each device is a dual radio that includes a Bluetooth™ radio and a WLAN radio. All devices in an ad hoc network may participate in propagating the discovered WLAN epoch timing information to further inquiring devices in a distributed manner by using standard Bluetooth™ inquiry information. A wireless ad-hoc network may have a peer to peer communication when two wireless devices come within communication range of each other or a mesh topology formed in an ad hoc manner when several wireless devices come within communication range of each other.

In wireless ad hoc networks, the wireless distribution system is a mesh of interoperable wireless links or multi-hop paths. Optionally, end devices may establish interoperable peer-to-peer wireless links with neighboring end devices and access points (APs) in a wireless mesh network. Mesh devices such as for example mesh stations (STAs) may support mesh services, i.e. they participate in interoperable formation and operation of a mesh basic service set (MBSS). A mesh basic service set (MBSS) is a basic service set (BSS) that forms a self-contained network of mesh devices, and which may be used as a distribution system. The configuration of a mesh STA that is collocated with an access point allows a single device to logically provide both mesh functionalities and AP functionalities simultaneously.

FIG. 5A illustrates an example embodiment of a wireless ad hoc network wherein each device is a dual radio that includes wireless communication technology such as for example a Bluetooth™ radio and a WLAN radio. In example embodiments of the invention, wireless ad hoc networks propagate synchronization among the devices in the ad hoc network. All devices in a mesh network may participate in propagating the discovered WLAN activity epoch timing information to further inquiring devices in a distributed manner by using Bluetooth™ inquiry information.

In example embodiments of the invention, a dual radio device having both a WLAN radio and a Bluetooth™ radio, uses its Bluetooth™ native clock to synchronize periods of wireless ad hoc network activity among participating nodes in a wireless ad hoc network. This provides a low-power enabler for network discovery and background activity of low-bandwidth, non-latency sensitive data transfer between devices participating in a wireless ad hoc network. The example embodiments of the invention may reduce high power consumption associated with the scanning/discovery and data transfer between devices in a wireless network.

The exemplary wireless ad hoc network of FIG. 5A includes dual radio devices capable of wirelessly connecting to each other via one or more wireless links. Nodes and/or devices that belong to the ad hoc or mesh network may be called mesh devices or mesh STAs. All mesh STAs may comprise the same capability. Each mesh station (STA) is capable of forwarding traffic. Each mesh STA may transmit beacons as per beacon interval determined by each mesh STA individually. Mesh STAs may authenticate each other and provide a means to establish and manage links and peerings between mesh STAs. Peering is a logical relationship between two neighboring mesh STAs. A mesh network operates on the medium access control (MAC)-level and may operate as a bridge. Data type frame transmissions occur in links that a mesh STA establishes with neighbor mesh STAs. A link is a result of a peering in which two neighboring mesh STAs authenticate each other. Actual data delivery occurs across paths that are established on top of links. Paths are either single-hop or multi-hop paths depending on the number of links along the path. Any higher layer, e.g. the internet protocol (IP) layer for networking, may consider a mesh network as a single hop and does not need to be aware of mesh operations.

A logical peering relationship may be established from one mesh STA to another mesh STA with a mesh peering management protocol. Mesh STAs may participate with other mesh STAs in mesh functionalities such as path selection and forwarding. Mesh STAs may propagate mesh frames over multiple hops and connectivity is provided to all member STAs.

Data transmission occurs at the link layer using mesh paths that are formed out of links. Link and peering can be established only to a mesh STA from which beacon frames can be received. Each mesh STA is responsible for participating in all the functionality essential for multi-hop data delivery in the mesh network. Data is forwarded across the paths between mesh STAs.

The several wireless mesh devices shown in the network of FIG. 5A may each have substantially the same dual radio organization and components shown for the initiator device A and the discoverer device B of FIG. 1A and FIG. 4. Generally, wireless mesh devices STA-MP1, STA-MP2, STA-MP3, STA-MP4, etc. include a wireless mesh network MAC and a transceiver configured to receive a plurality of wireless beacon messages from other wireless mesh devices in the wireless ad hoc network 520. Wireless mesh device STA-MP1 is shown as the initiator device in the wireless ad hoc network 520.

In FIG. 5A, the initiator device STA-MP1 uses the HCI Read Clock Command to read the current value of the Bluetooth™ native clock CLKN(A) at sequential times T. FIG. 5A shows the initiator device STA-MP1 transmitting to the discoverer device STA-MP2 an inquiry response packet 155 containing the native clock CLKN(MP1) at various times T and an accompanying extended inquiry response packet 160 containing the value for N and the value for Σ(OFFSET)(MP1). The discoverer device STA-MP2 uses Equation 1 to compute SYNCLK(MP2)[T] at sequential times T. The resulting synchronized WLAN activity epochs 180 of the WLAN radio of discoverer device STA-MP2, are synchronized with the WLAN activity epochs 170 of the WLAN radio of initiator device STA-MP1, in accordance with example embodiments of the invention.

Similarly, FIG. 5A shows the device STA-MP2 transmitting to the third device STA-MP3 an inquiry response packet 155′ containing the native clock CLKN(MP2) at various times T and an accompanying extended inquiry response packet 160′ containing the value for N and the value for Σ(OFFSET)(MP2). FIG. 5A shows the third device STA-MP3 using Equation 1 to compute SYNCLK(MP3)[T] at sequential times T. The resulting synchronized WLAN activity epochs 180 of the WLAN radio of wireless third device STA-MP3, are synchronized with the WLAN activity epochs 170 of the WLAN radio of initiator device STA-MP1, in accordance with example embodiments of the invention.

Similarly, FIG. 5A shows the third device STA-MP3 transmitting to the fourth device STA-MP4 an inquiry response packet 155″ containing the native clock CLKN(MP3) at various times T and an accompanying extended inquiry response packet 160″ containing the value for N and the value for Σ(OFFSET)(MP3). FIG. 5A shows the fourth device STA-MP4 using Equation 1 to compute SYNCLK(MP4)[T] at sequential times T. The resulting synchronized WLAN activity epochs 180 of the WLAN radio of wireless Fourth device STA-MP4, are synchronized with the WLAN activity epochs 170 of the WLAN radio of initiator device STA-MP1, in accordance with example embodiments of the invention.

FIG. 5B illustrates an example timing diagram of the wireless mesh third device STA-MP3 and wireless mesh fourth device STA-MP4 of FIG. 5A, showing an example relationship between the Bluetooth™ native clock CLKN of the Bluetooth™ radio and the WLAN activity of the WLAN radio in synchronizing the mesh devices, in accordance with at least one embodiment of the present invention. The third device STA-MP3 is shown transmitting to the fourth device STA-MP4 an inquiry response packet 155″ containing the native clock CLKN(MP3) at various times T and an accompanying extended inquiry response packet 160″ containing the value for N and the value for Σ(OFFSET)(MP3). The fourth device STA-MP4 uses Equation 1 to compute SYNCLK(MP4)[T] at sequential times T. The resulting synchronized WLAN activity epochs 180″ of the WLAN radio of wireless fourth device STA-MP4, are synchronized with the WLAN activity epochs 170 of the WLAN radio of initiator device STA-MP1, in accordance with example embodiments of the invention.

FIG. 5C is a more detailed illustration of the timing diagram of FIG. 5B, showing an example of the beacons and data frames transmitted during one activity epoch 180″ of duration Δ of approximately one second duration. The devices in the wireless ad hoc network have been synchronized using native clock timing of the Bluetooth™ native clock CLKN of the Bluetooth™ radio to synchronize the WLAN activity of the WLAN radio of the ad hoc network, in accordance with at least one embodiment of the present invention. The wireless mesh devices STA-MP1, STA-MP2, STA-MP3, and STA-MP4 are synchronized and are shown transmitting beacons and data frames during the WLAN or mesh activity epoch Δ of approximately one second duration. The wireless ad hoc network uses carrier sense multiple access with collision avoidance (CSMA/CA) as the access method for beacons and data frames. The synchronization mechanism is distributed among the devices in the wireless ad hoc network. The wireless mesh device STA-MP1 that starts the ad hoc network will begin by resetting its timing synchronization function (TSF) timer to zero and transmitting a beacon, choosing a beacon period. This establishes the basic beaconing process for the ad hoc network. After the ad hoc network has been established, each device in the ad hoc network will attempt to send a beacon after the target beacon transmission time (TGTT) arrives. To minimize actual collisions of the transmitted beacon frames on the medium, each device in the ad hoc network will choose a random delay value which must expire before it attempts its beacon transmission. During each WLAN activity epoch Δ, the synchronized wireless mesh devices may participate in WLAN beacon transmission and data transfer, according to defined procedures. If a device is unable to transmit a packet before the end of the WLAN activity epoch Δ, it queues the packet for transmission (using normal contention based access) in the next epoch. This is considered sufficient for low-bandwidth, non latency-sensitive/broadcast traffic. After the expiration of the WLAN activity epoch Δ, the WLAN radio of each device may powered off.

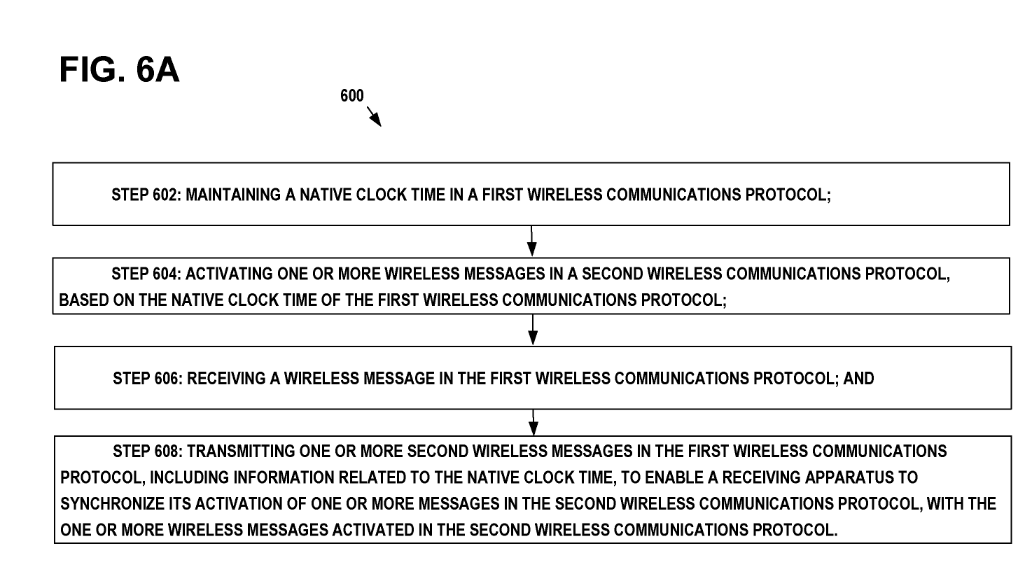

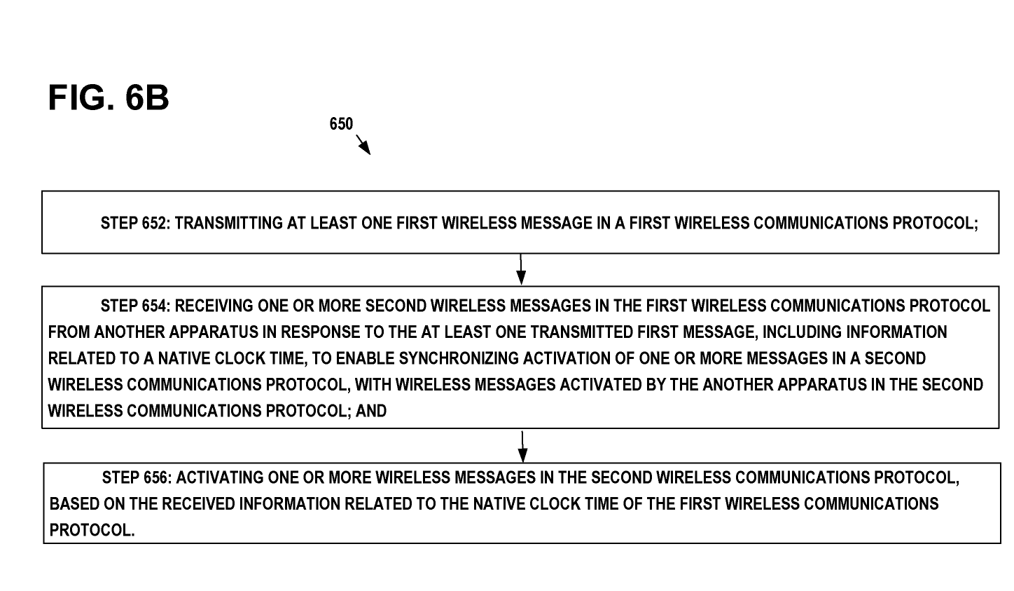

FIG. 6A is an example flow diagram 600 of operational steps in using native clock timing of a first wireless communications protocol to establish synchronization of an ad hoc network of a second wireless communications protocol. The steps of the flow diagram of FIG. 6A represent computer code instructions stored in the RAM 426 and/or ROM 427 memory of the initiator device A of FIG. 1A and FIG. 4, which when executed by the central processing units (CPU) 424 and/or 425, carry out the functions of a example embodiment of the invention. Alternately, some or all of the steps in the procedure of the flow diagram may be embodied as hardware program logic included in programmed logic arrays of sequential and/or combinatorial logic circuits and/or state machine logic implementing some or all of the steps performed by embodiments of the invention. The steps may be carried out in another order than shown and individual steps may be combined or separated into component steps. The method includes the steps of:

Step 602: maintaining a native clock time in a first wireless communications protocol;

Step 604: activating one or more wireless messages in a second wireless communications protocol, based on the native clock time of the first wireless communications protocol;

Step 606: receiving a wireless message in the first wireless communications protocol; and

Step 608: transmitting one or more second wireless messages in the first wireless communications protocol, including information related to the native clock time, to enable a receiving apparatus to synchronize its activation of one or more messages in the second wireless communications protocol, with the one or more wireless messages activated in the second wireless communications protocol.

FIG. 6B is an example flow diagram 650 of operational steps in using native clock timing of a first wireless communications protocol to establish synchronization of an ad hoc network of a second wireless communications protocol. The steps of the flow diagram of FIG. 6B represent computer code instructions stored in the RAM 426 and/or ROM 427 memory of the discovering device B of FIG. 1A and FIG. 4, which when executed by the central processing units (CPU) 424 and/or 425, carry out the functions of a example embodiment of the invention. Alternately, some or all of the steps in the procedure of the flow diagram may be embodied as hardware program logic included in programmed logic arrays of sequential and/or combinatorial logic circuits and/or state machine logic implementing some or all of the steps performed by embodiments of the invention. The steps may be carried out in another order than shown and individual steps may be combined or separated into component steps. The method includes the steps of:

Step 652: transmitting at least one first wireless message in a first wireless communications protocol;

Step 654: receiving one or more second wireless messages in the first wireless communications protocol from another apparatus in response to the at least one transmitted first message, including information related to a native clock time, to enable synchronizing activation of one or more messages in a second wireless communications protocol, with wireless messages activated by the another apparatus in the second wireless communications protocol; and

Step 656: activating one or more wireless messages in the second wireless communications protocol, based on the received information related to the native clock time of the first wireless communications protocol.

In example embodiments of the invention, since the relative occupancy of the Industrial, Scientific and Medical (ISM) band by both Bluetooth and WLAN systems is low, because the probability that the WLAN activity epoch interval coincides with Bluetooth inquiry/inquiry response is low, it is sufficient to assign all Bluetooth inquiry/response transmissions from the dual radio device, as having a higher priority than the WLAN transmissions from the device. If WLAN transmissions in one WLAN activity epoch duration are deferred to the next WLAN activity epoch because they occur in the midst of performing a Bluetooth device inquiry, this will not significantly affect the performance of the overall system, since only one WLAN activity epoch will be affected. Even where there is significant Bluetooth traffic concurrent with WLAN traffic, accomplishing the coordination of the WLAN activity epochs among the devices only involves transmission of the Bluetooth inquiry response packet 155 and the Bluetooth extended inquiry response packet 160.

In alternate example embodiments of the invention, WLAN-Bluetooth coexistence interference mitigation schemes may be used when there is significant Bluetooth traffic concurrent with WLAN traffic. A software technique may be used in embodiments of the invention, for handling interference between the Bluetooth and WLAN transmissions by the dual radio device.

Example embodiments of the invention may be applied to ad hoc radio networks that carry awareness information consisting of small, anonymous messages that are exchanged by the automatically by the devices, without human intervention. Anonymous, in this context, means that it is not possible to infer the true identity of the sender from the message, unless it has been intentionally included in the message.

Example embodiments of the invention use standard Bluetooth™ discovery techniques in order to propagate timing information of ad hoc network activity periods (WLAN activity epochs) to all WLAN nodes wishing to participate in the ad hoc network. At all times other than during the WLAN activity epoch, the WLAN radio of each device is powered off. The timing of each epoch is based on a multiple of the Bluetooth™ clock rate (3.2 kHz), for example 20.48 second or 40.96 second intervals. Each epoch is a short period of activity, for example 1 second, during which nodes may participate in WLAN beacon transmission and data transfer in the ad hoc network.

In example embodiments of the invention, ad hoc networks facilitate device interaction while conserving device resources. Example embodiments of the invention may be applied to ad hoc radio networks that carry awareness information, wherein devices may stay synchronized with an ad hoc network utilizing a reduced or diluted beacon interval that is an integer multiple of a network beacon period signal being transmitted at a set interval. Diluted beacon intervals may the reduce communication burden for devices, since the need to communicate occurs less frequently. However, as periods of inactivity increase during diluted beacon intervals it becomes easier for devices to slip out of synchronization with the timing of the ad hoc network.

Example embodiments of the invention may be applied to ad hoc radio networks that carry awareness information, wherein devices may resynchronize with an ad hoc network. Devices may be active in the ad hoc network in accordance with an awake window. During an awake window a device may transmit a beacon and then enter into an empty queue state (e.g., no data still pending for transmission) or non-empty queue state (e.g., data still pending for transmission). Concurrently with these operations, a set time during the awake window may delineate a period of time after which any beacon signal received from another device is deemed to be late. Receiving late beacon signals in a device may trigger the device to perform various operations that may help bring devices that issued late beacons back into synchronization.

Example embodiments of the invention may be applied to ad hoc radio networks that carry awareness information, wherein devices that receive late beacon signals may transmit additional beacon signals in order to assist other devices realign to the ad hoc network beacon signal interval, or alternatively to a diluted beacon interval based on an integer multiple of the network beacon signal interval. Devices in a non-empty queue state may first transmit pending data before attempting to transmit an additional beacon. Devices may then participate in contention in the ad hoc network for communication access. Once access to the communication channel is granted, the device may transmit an additional beacon and then return to the non-empty queue state. Only one additional beacon signal may be transmitted by a device in an awake state period. Devices in the ad hoc network may synchronize or resynchronize using standard Bluetooth™ discovery techniques in order to propagate timing information of wireless ad hoc network activity periods (WLAN activity epochs) to all WLAN nodes wishing to participate in the wireless ad hoc network.

Example embodiments of the invention may be applied to ad hoc radio networks that carry awareness information, wherein devices may, upon identifying a scanning opportunity, opt either to utilize the scanning opportunity or to participate in ad hoc network beaconing (e.g., when a scanning opportunity occurs during a TBTT also associated with a diluted beacon period). In example scenarios where devices opt to utilize a scanning opportunity, devices may prepare an ad hoc network information message prior to entering a passive scanning mode. These devices may remain in the passive scanning mode for the duration of the scanning opportunity, reacting in scenarios where messages are received from devices outside of the ad hoc network. For example, devices may receive beacon signals from other networks identified, for example, by having a different SSID, which may trigger transmission of the network information message. Prior to transmission, network information messages may be altered to include SSIDs corresponding to receive beacon signals.

Example embodiments of the invention may be applied to ad hoc radio networks that carry awareness information, wherein the ad hoc network information messages may comprise communication configuration information usable by devices outside of the network for interacting with apparatuses in the network. For example, beacon period information may be provided so that outside devices may synchronize to the timing of the ad hoc network. Beacon period information may also comprise reduced beacon period information for devices that desire/need to interact less frequently. Devices in the ad hoc network may synchronize or resynchronize using standard Bluetooth™ discovery techniques in order to propagate timing information of wireless ad hoc network activity periods (WLAN activity epochs) to all WLAN nodes wishing to participate in the wireless ad hoc network.

Example embodiments of the invention may be applied to ad hoc radio networks that carry awareness information, wherein devices in the ad hoc network may rely on messages that follow strict semantics and are understandable to the other clients. Combined with storage and reasoning in user devices, the ad hoc network gives rise to a local semantic web, where local information is created and searched for more or less automatically. Utilizing the larger storage space becoming available in mobile devices, it is possible to store all the information that flows through a given device for days or months. For practically any location, there is a set of devices that always return to the scene as their users either work or live in the neighborhood. Also fixed nodes may be added by interested parties as part of such a local semantic database to enable advertising through these devices via the ad hoc network.

In example embodiments of the invention, such awareness and presence services may also be implemented using client-server architecture, in addition to a peer-to-peer architecture. However, the more local and temporally dynamic the services are, the harder it is to realize them solely with servers. Possible privacy concerns in presence or location-based services may be alleviated, if there is no need to send geographical position data continuously to a set of servers. In example embodiments of the invention, a combination of client-server architecture, in addition to a peer-to-peer architecture enables awareness and presence services in an ad hoc network.

In example embodiments of the invention, an ad hoc network uses local radio effectively for effective dissemination of awareness information. The communication may be active all the time, but still have only a small impact on the battery lifetime. At the same time, the range of operation may be sufficient for multi-hop operation in a rapidly varying WLAN mesh network topology.

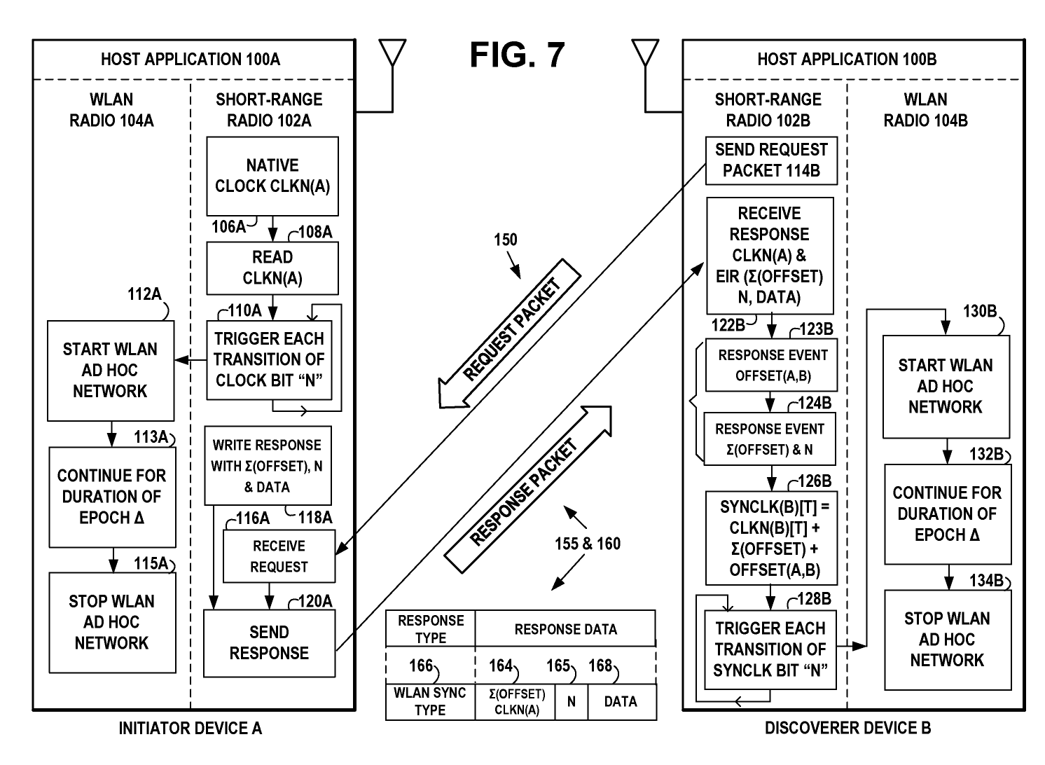

FIG. 7 illustrates an example generalized network diagram of an initiator device A and a discoverer device B, where each device is a dual radio that includes a generalized short-range radio 102A in device A and 102B in device B and a generalized wireless local area network (WLAN) radio 104A in device A and 104B in device B. The principles of operation and the components shown in FIG. 7, of devices A and B are substantially the same as those of devices

A and B in FIG. 1A, in accordance with at least one embodiment of the present invention. The request packet 150 in FIG. 7 is a generalization that corresponds to the inquiry packet 150 shown in FIG. 1A. The response packet 155 & 160 in FIG. 7 is a generalization that corresponds to the inquiry response 155 and extended inquiry response 160 shown in FIG. 1A.

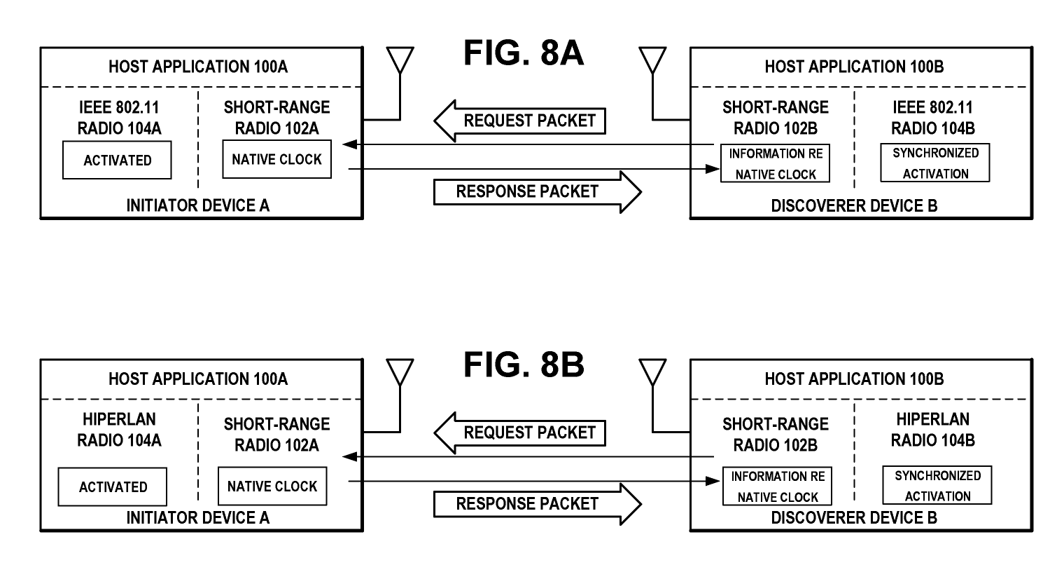

FIG. 8A illustrates an example network diagram of an initiator device A and a discoverer device B, where each device is a dual radio that includes a short-range radio 102A in device A and 102B in device B and a IEEE 802.11 radio 104A in device A and 104B in device B. IEEE 802.11 is published in IEEE 802.11-2007, Wireless Medium Access Control (MAC) and Physical Layer (PHY) Specifications, June 2007. The principles of operation of devices A and B are substantially the same as those of devices A and B in FIG. 1A and FIG. 7, in accordance with at least one embodiment of the present invention.

FIG. 8B illustrates an example network diagram of an initiator device A and a discoverer device B, where each device is a dual radio that includes a short-range radio 102A in device A and 102B in device B and a HIPERLAN radio 104A in device A and 104B in device B. HIPERLAN is published in the HIPERLAN Type 1 Standard, ETSI ETS 300 652 Radio Equipment and Systems (RES); High Performance Radio Local Area Network, December 1997. The principles of operation of devices A and B are substantially the same as those of devices A and B in FIG. 1A and FIG. 7, in accordance with at least one embodiment of the present invention.

Example embodiments of the invention in the generalized network diagram of FIG. 7, may include a short-range radio 102A in initiator device A and 102B in discoverer device B based on the Bluetooth LE protocol. The initiator device A may send a scannable undirected Event (ADV_SCAN_IND) at regular intervals defined by T_advEvent. The discoverer device B may be in the scanning state as default. The discoverer device B would then send a SCAN_REQ PDU (corresponding to the request packet 150 in FIG. 7) to the initiator device A following reception of a ADV_SCAN_IND PDU. The initiator device A would then send a SCAN_RSP PDU (corresponding to the response packet 155 & 160 in FIG. 7) to the discoverer device B, containing further data relevant for WLAN activation. (Overall 62 bytes of data is available in the ADV_SCAN_IND_PDU and the SCAN_RSP_PDU for the initiator device B to communicate information regarding the WLAN activation time.) In example embodiments of the invention, the initiator device A may synchronize the WLAN to the advertising events themselves (or multiples thereof), with a certain fixed offset. There may be a 10 ms ambiguity due to the random delay of advertising packet transmissions (advDelay), which may be accommodated for in the WLAN epoch duration. Discovering devices may then advertise the calculated offset at a different T_advEvent time with respect to the same WLAN activation time. Timing drift between devices in the network may require regular re-scanning for advertising packets, and updating of the offset in the devices' own advertising packet transmissions.

According to an example embodiment of the invention, an apparatus comprises:

means for maintaining a native clock time in a first wireless communications protocol;

means for activating one or more wireless messages in a second wireless communications protocol, based on the native clock time of the first wireless communications protocol;

means for receiving a wireless message in the first wireless communications protocol; and

means for transmitting one or more second wireless messages in the first wireless communications protocol, including information related to the native clock time, to enable a receiving apparatus to synchronize its activation of one or more messages in the second wireless communications protocol, with the one or more wireless messages activated in the second wireless communications protocol.

According to an example embodiment of the invention, an apparatus comprises:

means for transmitting at least one first wireless message in a first wireless communications protocol;

means for receiving one or more second wireless messages in the first wireless communications protocol from another apparatus in response to the at least one transmitted first message, including information related to a native clock time, to enable synchronizing activation of one or more messages in a second wireless communications protocol, with wireless messages activated by the another apparatus in the second wireless communications protocol; and

means for activating one or more wireless messages in the second wireless communications protocol, based on the received information related to the native clock time of the first wireless communications protocol.

Example embodiments of the invention further comprise:

the at least one memory and the computer program code configured to, with the at least one processor, cause the apparatus at least to:

include in the one or more second wireless messages in the first wireless communications protocol, information related to the predetermined value of the native clock time.

Example embodiments of the invention further comprise:

the at least one memory and the computer program code configured to, with the at least one processor, cause the apparatus at least to:

include in the one or more second wireless messages in the first wireless communications protocol, an offset value and a value of a logarithm to base two of the predetermined value of the native clock time, minus a value of one.

Example embodiments of the invention further comprise:

the at least one memory and the computer program code configured to, with the at least one processor, cause the apparatus at least to:

receive an offset value and information related to a predetermined value for an activation time of the second wireless communications protocol based on a remote native clock time in one or more wireless messages in the first wireless communications protocol;

start a period for the activation of the one or more wireless messages in the second wireless communications protocol, based on the received predetermined value for the activation time of the second wireless communications protocol based on the received offset of the remote native clock time; and

include in the one or more second wireless messages in the first wireless communications protocol information related to the predetermined value for the activation time of the second wireless communications protocol and a second offset based on the local native clock time and the received offset value.

Example embodiments of the invention further comprise:

the at least one memory and the computer program code configured to, with the at least one processor, cause the apparatus at least to:

receive an accumulated offset value and information related to a predetermined value for an activation time of the second wireless communications protocol based on a remote native clock time, in one or more wireless messages in the first wireless communications protocol;

start a period for the activation of the one or more wireless messages in the second wireless communications protocol, based on the received predetermined value for the activation time of the second wireless communications protocol based on the received accumulated offset to the remote native clock time; and

include in the one or more second wireless messages in the first wireless communications protocol information related to the predetermined value for the activation time of the second wireless communications protocol and a second offset based on the local native clock time and an accumulated offset value.

Example embodiments of the invention further comprise:

wherein the second wireless communications protocol is one of IEEE 802.11 or HIPERLAN.

Example embodiments of the invention further comprise:

wherein the first wireless communications protocol is Bluetooth.

Example embodiments of the invention further comprise:

wherein the first wireless communications protocol is Bluetooth, the received wireless message in the first wireless communications protocol is an inquiry request, and the one or more second wireless messages in the first wireless communications protocol are at least one of an inquiry response and an extended inquiry response.

Example embodiments of the invention further comprise:

wherein the first wireless communications protocol is Bluetooth, the second wireless communications protocol is a wireless local area network, and the one or more wireless messages in the second wireless communications protocol include at least one beacon.

Using the description provided herein, the embodiments may be implemented as a machine, process, or article of manufacture by using standard programming and/or engineering techniques to produce programming software, firmware, hardware or any combination thereof.

Some or all of the steps in the flow diagrams disclosed herein may be embodied as hardware program logic included in programmed logic arrays of sequential and/or combinatorial logic circuits and/or state machine logic implementing some or all of the steps performed by embodiments of the invention.

Any resulting program(s), having computer-readable program code, may be embodied on one or more computer-usable media such as resident memory devices, smart cards or other removable memory devices, or transmitting devices, thereby making a computer program product or article of manufacture according to the embodiments. As such, the terms “article of manufacture” and “computer program product” as used herein are intended to encompass a computer program that exists permanently or temporarily on any computer readable non-transitory medium.

As indicated above, memory/storage devices include, but are not limited to, disks, optical disks, removable memory devices such as smart cards, SIMs, WIMs, semiconductor memories such as RAM, ROM, PROMS, etc. Transmitting mediums include, but are not limited to, transmissions via wireless communication networks, the Internet, intranets, telephone/modem-based network communication, hard-wired/cabled communication network, satellite communication, and other stationary or mobile network systems/communication links.

Although specific example embodiments have been disclosed, a person skilled in the art will understand that changes can be made to the specific example embodiments without departing from the spirit and scope of the invention.

1. A method comprising:
maintaining a native clock time in a first wireless communications protocol;
activating one or more wireless messages in a second wireless communications protocol, based on the native clock time of the first wireless communications protocol;
receiving a wireless message in the first wireless communications protocol; and
transmitting one or more second wireless messages in the first wireless communications protocol, including information related to the native clock time, to enable a receiving apparatus to synchronize its activation of one or more messages in the second wireless communications protocol, with the one or more wireless messages activated in the second wireless communications protocol.

2. The method of claim 1, further comprising:
starting a period for the activation of the one or more wireless messages in the second wireless communications protocol, based on a predetermined value of the native clock time.

3. The method of claim 2, further comprising:
including in the one or more second wireless messages in the first wireless communications protocol, information related to the predetermined value of the native clock time.

4. The method of claim 2, further comprising:
including in the one or more second wireless messages in the first wireless communications protocol, an offset value and a value of a logarithm to base two of the predetermined value of the native clock time, minus a value of one.

5. The method of claim 1, further comprising:
receiving an offset value and information related to a predetermined value for an activation time of the second wireless communications protocol based on a remote native clock time in one or more wireless messages in the first wireless communications protocol;
starting a period for the activation of the one or more wireless messages in the second wireless communications protocol, based on the received predetermined value for the activation time of the second wireless communications protocol based on the received offset of the remote native clock time; and
including in the one or more second wireless messages in the first wireless communications protocol information related to the predetermined value for the activation time of the second wireless communications protocol and a second offset based on the local native clock time and the received offset value.

6. The method of claim 1, further comprising:
receiving an accumulated offset value and information related to a predetermined value for an activation time of the second wireless communications protocol based on a remote native clock time in one or more wireless messages in the first wireless communications protocol;
starting a period for the activation of the one or more wireless messages in the second wireless communications protocol, based on the received predetermined value for the activation time of the second wireless communications protocol based on the received accumulated offset to the remote native clock time; and
including in the one or more second wireless messages in the first wireless communications protocol information related to the predetermined value for the activation time of the second wireless communications protocol and a second offset based on the local native clock time and an accumulated offset value.

7. The method of claim 1, wherein the second wireless communications protocol is one of IEEE 802.11 or HIPERLAN.

8. The method of claim 1, wherein the first wireless communications protocol is Bluetooth.

9. The method of claim 1, wherein the first wireless communications protocol is Bluetooth, the received wireless message in the first wireless communications protocol is an inquiry request, and the one or more second wireless messages in the first wireless communications protocol are at least one of an inquiry response and an extended inquiry response.

10. The method of claim 1, wherein the first wireless communications protocol is Bluetooth, the second wireless communications protocol is a wireless local area network, and the one or more wireless messages in the second wireless communications protocol include at least one beacon.

11. An apparatus comprising:
at least one processor;
at least one memory including computer program code;
the at least one memory and the computer program code configured to, with the at least one processor, cause the apparatus at least to:
maintain a native clock time in a first wireless communications protocol;
activate one or more wireless messages in a second wireless communications protocol, based on the native clock time of the first wireless communications protocol;
receive a wireless message in the first wireless communications protocol; and
transmit one or more second wireless messages in the first wireless communications protocol, including information related to the native clock time, to enable a receiving apparatus to synchronize its activation of one or more messages in the second wireless communications protocol, with the one or more wireless messages activated in the second wireless communications protocol.

12. The apparatus of claim 11, further comprising:
the at least one memory and the computer program code configured to, with the at least one processor, cause the apparatus at least to:
start a period for the activation of the one or more wireless messages in the second communications protocol, based on a predetermined value of the native clock time.

13. (canceled)

14. (canceled)

15. (canceled)

16. (canceled)

17. (canceled)

18. (canceled)

19. (canceled)

20. (canceled)

21. A computer program product comprising computer executable program code recorded on a computer readable non-transitory storage medium, the computer executable program code, when executed by a computer processor, causing performance of the steps of:
maintaining a native clock time in a first wireless communications protocol;
activating one or more wireless messages in a second wireless communications protocol, based on the native clock time of the first wireless communications protocol;
receiving a wireless message in the first wireless communications protocol; and
transmitting one or more second wireless messages in the first wireless communications protocol, including information related to the native clock time, to enable a receiving apparatus to synchronize its activation of one or more messages in the second wireless communications protocol, with the one or more wireless messages activated in the second wireless communications protocol.

22. A method comprising:
transmitting at least one first wireless message in a first wireless communications protocol;
receiving one or more second wireless messages in the first wireless communications protocol from another apparatus in response to the at least one transmitted first message, including information related to a native clock time, to enable synchronizing activation of one or more messages in a second wireless communications protocol, with wireless messages activated by the another apparatus in the second wireless communications protocol; and
activating one or more wireless messages in the second wireless communications protocol, based on the received information related to the native clock time of the first wireless communications protocol.

23. The method of claim 22, further comprising:
starting a period for the activation of the one or more wireless messages in the second wireless communications protocol, based on a predetermined value of the native clock time.

24. The method of claim 22, further comprising:
the one or more second wireless messages received in the first wireless communications protocol including information related to a predetermined value of the native clock time and an offset value; and
starting a period for the activation of the one or more wireless messages in the second wireless communications protocol, based on the information related to predetermined value of the native clock time and the offset value.

25. The method of claim 22, wherein the one or more second wireless messages in the first wireless communications protocol are received from a source ad hoc network and the one or more wireless messages activated in the second wireless communications protocol are synchronized with one or more wireless messages activated in the second wireless communications protocol of the source ad hoc network.

26. The method of claim 22, wherein the first wireless communications protocol is Bluetooth, the at least one transmitted first wireless message in the first wireless communications protocol is an inquiry request, and the one or more second wireless messages in the first wireless communications protocol are at least one of an inquiry response and an extended inquiry response.

27. The method of claim 22, wherein the first wireless communications protocol is Bluetooth, the second wireless communications protocol is a wireless local area network and the one or more wireless messages in the second wireless communications protocol include at least one beacon.

28. An apparatus comprising:
at least one processor;
at least one memory including computer program code;
the at least one memory and the computer program code configured to, with the at least one processor, cause the apparatus at least to:
transmit at least one first wireless message in a first wireless communications protocol;
receive one or more second wireless messages in the first wireless communications protocol from another apparatus in response to the at least one transmitted first message, including information related to a native clock time, to enable synchronizing activation of one or more messages in a second wireless communications protocol, with wireless messages activated by the another apparatus in the second wireless communications protocol; and
activate one or more wireless messages in the second wireless communications protocol, based on the received information related to the native clock time of the first wireless communications protocol.

29. A computer program product comprising computer executable program code recorded on a computer readable non-transitory storage medium, the computer executable program code, when executed by a computer processor, causing performance of the steps of:
transmitting at least one first wireless message in a first wireless communications protocol;
receiving one or more second wireless messages in the first wireless communications protocol from another apparatus in response to the at least one transmitted first message, including information related to a native clock time, to enable synchronizing activation of one or more messages in a wireless second communications protocol, with wireless messages activated by the another apparatus in the second wireless communications protocol; and
activating one or more wireless messages in the second wireless communications protocol, based on the received information related to the native clock time of the first wireless communications protocol.
